(19) United States
(12) Patent Application Publication
(10) Pub. No.: US 2026/0017295 A1
(43) Pub. Date: Jan. 15, 2026

(54) METHOD AND APPARATUS FOR GENERATING QUESTION-ANSWERING SERVICE, DEVICE, AND READABLE STORAGE MEDIUM

(71) Applicant: TENCENT TECHNOLOGY (SHENZHEN) COMPANY LIMITED, Shenzhen (CN)

(72) Inventors: Shufan DENG, Shenzhen (CN); Zhiqiang DONG, Shenzhen (CN); Bin LI, Shenzhen (CN)

(21) Appl. No.: 19/338,962

(22) Filed: Sep. 24, 2025

Related U.S. Application Data
(63) Continuation of application No. PCT/CN2023/124736, filed on Oct. 16, 2023.

(30) Foreign Application Priority Data
Jul. 24, 2023 (CN) 202310914994.7

(51) Int. Cl. G06F 16/3329; G06F 11/34; G06F 21/60

(52) U.S. Cl. CPC G06F 16/33295; G06F 11/3476; G06F 21/602

(57) ABSTRACT

A question-answering service generation method includes displaying a functional code encapsulation component set in an edition interaction page of a question-answering service edition application, and in response to a component selection operation on the functional code encapsulation component set, displaying, in a question-answering service edition page included in the edition interaction page, a trigger component, a question-answering strategy component, and a language question-answering model component that are selected from the functional code encapsulation component set through the component selection operation, and a processing flow connection relationship among the trigger component, the question-answering strategy component, and the language question-answering model component, and generating, in response to a question-answering service confirmation operation triggered in the edition interaction page, a question-answering service based on the processing flow connection relationship.

### CROSS-REFERENCE TO RELATED APPLICATIONS

This application is a continuation of International Application No. PCT/CN2023/124736, filed on Oct. 16, 2023, which claims the priority to Chinese Patent Application No. 2023109149947 filed on Jul. 24, 2023 and entitled “Method and Apparatus for Generating Question-answering service, Device, and Readable Storage Medium,” the entire contents of both of which are incorporated herein by reference.

### FIELD OF THE TECHNOLOGY

This application relates to the technical field of computers, and in particular, to a method and apparatus for generating a question-answering service, a device, and a readable storage medium.

### BACKGROUND OF THE DISCLOSURE

At present, question-answering robots with a large language model face high technical thresholds and high research and development costs. The existing development methods all adopt code-based manual development. However, such manual development is inefficient and laborious, and makes enormous demands on implementation. To be specific, technicians are required to deeply understand an underlying algorithm of the large language model and prepare a huge training data set, resulting in high labor cost. Besides, tasks can only be completed through manual interference and development, during which human errors and loopholes are likely to occur. The implementation error rate is high, and the quality and efficiency of the work are affected accordingly.

### SUMMARY

In accordance with the disclosure, there is provided a question-answering service generation method performed by a computer device and including displaying a functional code encapsulation component set in an edition interaction page of a question-answering service edition application, and in response to a component selection operation on the functional code encapsulation component set, displaying, in a question-answering service edition page included in the edition interaction page, a trigger component, a question-answering strategy component, and a language question-answering model component that are selected from the functional code encapsulation component set through the component selection operation, and a processing flow connection relationship among the trigger component, the question-answering strategy component, and the language question-answering model component, and generating, in response to a question-answering service confirmation operation triggered in the edition interaction page, a question-answering service based on the processing flow connection relationship. The trigger component in the question-answering service is configured to invoke the question-answering strategy component from the question-answering service, the question-answering strategy component in the question-answering service is configured to perform, after receiving a service question, question-answering filtering on the service question to obtain a filtered service question, and the language question-answering model component in the question-answering service is configured to output a question-answering service result according to the filtered service question.

Also in accordance with the disclosure, there is provided a computer device including a processor and a memory storing computer-readable instructions that, when executed by the processor, cause the computer device to display a functional code encapsulation component set in an edition interaction page of a question-answering service edition application, and in response to a component selection operation on the functional code encapsulation component set, display, in a question-answering service edition page included in the edition interaction page, a trigger component, a question-answering strategy component, and a language question-answering model component that are selected from the functional code encapsulation component set through the component selection operation, and a processing flow connection relationship among the trigger component, the question-answering strategy component, and the language question-answering model component, and generate, in response to a question-answering service confirmation operation triggered in the edition interaction page, a question-answering service based on the processing flow connection relationship. The trigger component in the question-answering service is configured to invoke the question-answering strategy component from the question-answering service, the question-answering strategy component in the question-answering service is configured to perform, after receiving a service question, question-answering filtering on the service question to obtain a filtered service question, and the language question-answering model component in the question-answering service is configured to output a question-answering service result according to the filtered service question.

Also in accordance with the disclosure, there is provided a non-transitory computer-readable storage medium storing computer-readable instructions that, when executed by a processor, cause a computer device having the processor to display a functional code encapsulation component set in an edition interaction page of a question-answering service edition application, and in response to a component selection operation on the functional code encapsulation component set, display, in a question-answering service edition page included in the edition interaction page, a trigger component, a question-answering strategy component, and a language question-answering model component that are selected from the functional code encapsulation component set through the component selection operation, and a processing flow connection relationship among the trigger component, the question-answering strategy component, and the language question-answering model component, and generate, in response to a question-answering service confirmation operation triggered in the edition interaction page, a question-answering service based on the processing flow connection relationship. The trigger component in the question-answering service is configured to invoke the question-answering strategy component from the question-answering service, the question-answering strategy component in the question-answering service is configured to perform, after receiving a service question, question-answering filtering on the service question to obtain a filtered service question, and the language question-answering model component in the question-answering service is configured to output a question-answering service result according to the filtered service question.

### BRIEF DESCRIPTION OF THE DRAWINGS

To describe the technical solutions in the embodiments of this application more clearly, the accompanying drawings will be briefly described below. Apparently, the accompanying drawings in the following descriptions merely show some embodiments of this application, and those of ordinary skill in the art can still derive other accompanying drawings from these accompanying drawings without creative efforts.

FIG. 1 is a schematic diagram showing a network architecture according to an embodiment of this application;

FIG. 2 is a schematic diagram showing a scenario of generating a question-answering service according to an embodiment of this application;

FIG. 3 is a schematic diagram showing another scenario of generating a question-answering service according to an embodiment of this application;

FIG. 4 is a schematic flowchart of a method for generating a question-answering service according to an embodiment of this application;

FIG. 5 is a schematic diagram showing a scenario of generating a question-answering service according to an embodiment of this application;

FIG. 6 is a schematic flowchart showing accessing a question-answering service in a communication application according to an embodiment of this application;

FIG. 7 is a schematic flowchart of a method for generating a question-answering service according to an embodiment of this application;

FIG. 8 is a schematic structural diagram of an apparatus for generating a question-answering service according to an embodiment of this application; and

FIG. 9 is a schematic structural diagram of a computer device according to an embodiment of this application.

### DESCRIPTION OF EMBODIMENTS

Technical solutions of embodiments of this application will be described clearly below in conjunction with accompanying drawings of the embodiments of this application. Apparently, the embodiments described are merely some embodiments rather than all embodiments of this application. All other embodiments derived by a person of ordinary skill in the art from the embodiments of this application without creative efforts are to fall within the scope of this application.

The artificial intelligence technology is a comprehensive subject and involves a wide range of fields, for example, hardware-level technologies and software-level technologies. Basic technologies of artificial intelligence generally include technologies such as a sensor, a dedicated artificial intelligence chip, cloud computing, distributed storage, a big data processing technology, an operation/interaction system, and mechatronics. Software technologies of artificial intelligence mainly includes a computer vision technology, a voice processing technology, a natural language processing technology, machine learning/deep learning, etc.

Deep learning (DL) is to learn inherent laws and representation levels of sample data, and information obtained in these learning processes is of great help to the interpretation of data such as words, images, and sounds. A final objective of deep learning is to make a machine have capacities of analysis and learning like a human being, and be capable of identifying data such as the words, the images, and the sounds. Deep learning is a complex machine learning algorithm, and its effects achieved in speech and image identification are far beyond effects in speech and image identification of the related art.

The solution according to the embodiment of this application relates to artificial intelligence, which is specifically described through the following embodiment.

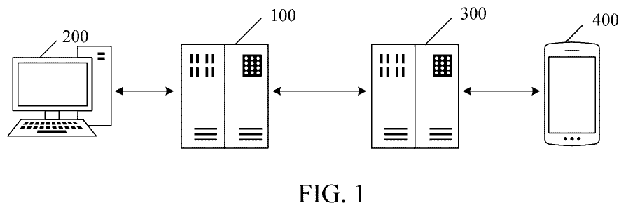

FIG. 1 is a schematic diagram showing a network architecture according to an embodiment of this application. The network architecture may include a work server 100, a terminal device 200, a communication server 300, and a terminal device 400. The work server 100 may be in communication connection to the terminal device 200, the work server 100 may be in communication connection to the communication server 300, and the communication server 300 may be in communication connection to the terminal device 400. The communication connection is not limited in connection methods, and may be a direct or indirect connection through wired communication, or may be a direct or indirect connection through wireless communication or other methods, which is not limited herein in this application.

The terminal device 200 may be provided with a question-answering service edition application. When the question-answering service edition application runs in the terminal device 200, the question-answering service edition application may perform data interaction with the work server 100. The work server 100 is also a background server of the question-answering service edition application. The terminal device 200 may generate a question-answering service through the question-answering service edition application, and the question-answering service may be accessed through a communication application. The terminal device 400 may be provided with the communication application. When the communication application runs in the terminal device 400, the communication application may perform data interaction with the communication server 300. The communication server 300 is also a background server of the communication application. The question-answering service refers to a smart service that may generate an answer to a question through a language question-answering model. The question-answering service may be an independent client or may be an embedded sub-client integrated in the communication application. The work server 100 and the communication server 300 may be integrated into a same server, and the terminal device 200 and the terminal device 400 may also be a same terminal device, which is not limited herein.

Specifically, the terminal device 200 is provided with a question-answering service edition application. The question-answering service edition application of the terminal device 200 may display a functional code encapsulation component set. The functional code encapsulation component set includes one or more trigger components, one or more question-answering strategy components, and one or more language question-answering model components.

The functional code encapsulation component refers to a pre-programmed functional component having a preset code function. The functional code encapsulation component may be a component that is formed by using at least one encapsulation in a pre-programmed program module or library and has a predetermined functional function. The functional function is configured to perform function processing on a service question inputted by a user. The trigger component is a component that triggers a workflow of the question-answering service, and serves as an initial component for running of the entire workflow of the question-answering service. The trigger component may be configured to measure whether the service question raised by the user satisfies a question-answering trigger condition, and may invoke the question-answering strategy component in the question-answering service when the question satisfies the question-answering trigger condition. The question-answering strategy component is a component for filtering the service question, and may filter the service question that is incapable of being processed by the language question-answering model component. The language question-answering model component may perform semantic identification on a filtered service question, and output a question-answering service result of the service question.

The terminal device 200 may trigger a component selection operation in the question-answering service edition application, and select the functional code encapsulation components from a question-answering service edition page of the question-answering service edition application. The functional code encapsulation component may be selected by dragging the functional code encapsulation component displayed in the question-answering service edition page or by creating a new functional code encapsulation component. Selected functional code encapsulation components are displayed in the edition page of the question-answering service edition application, and then a processing flow connection relationship is created between the selected functional code encapsulation components through a connection line. The processing flow connection relationship may represent a sequential order of processes of at least two functional code encapsulation components. The connection line may be an automatic connection on the basis of a preset rule, or may be a connection line triggered in response to a connection operation on the functional code encapsulation component.

The terminal device 200 may trigger a component configuration operation in the question-answering service edition application, display a parameter configuration page, and further modify component information of the functional code encapsulation component in the parameter configuration page of the question-answering service edition application. The component information may include the processing flow connection relationship, an instance name, and an instance template identifier. The instance name is a user-defined name of the functional code encapsulation component. The instance template identifier is configured for determining the functional function applied to the functional code encapsulation component, and the function processing is performed on the service question through the functional function. For example, a permission determination sub-component in the question-answering strategy component may search, through the functional function userlist.find( ), userlist (a question permission range) that has a questioning permission, and filter a service question that fails to return a result.

The terminal device 200 may generate, in response to a confirmation operation on the trigger component, the question-answering service based on the processing flow connection relationship among the trigger component, the question-answering strategy component, and the language question-answering model component that are selected in the question-answering service edition application.

The question-answering service may be accessed by the communication application, and the terminal device 400 is provided with the communication application. The communication application of the terminal device 400 may display a question-answering interaction page, and the user may input the service question into the question-answering interaction page. The service question includes a trigger parameter. When the trigger parameter satisfies the question-answering trigger condition indicated by the trigger component in the question-answering service, the terminal device 400 may transmit the service question to the communication server 300, and the communication server 300 forwards the service question to the work server 100. The work server 100 processes the service question through the functional code encapsulation component selected for the question-answering service, obtains the question-answering service result of the service question, and returns the question-answering service result to the communication server 300. The communication server 300 transmits the question-answering service result to the terminal device 400, and the communication application in the terminal device 400 may display, in the question-answering interaction page, the question-answering service result of the service question inputted by the user. The question-answering interaction page may be a window, a floating layer, or another form, which is not limited herein.

According to the embodiment of this application, various functional code encapsulation components supporting independent deployment can be provided, the functional code encapsulation components can be accessed flexibly, and the question-answering service can be generated based on the processing flow connection relationship between the functional code encapsulation components selected by the user. In this way, the user without professional programming knowledge can develop the question-answering service through the visual functional code encapsulation components and the processing flow connection relationships instead of writing codes. Thus, development production efficiency and universality of the question-answering service are improved, and development cost and implementation error rates are reduced.

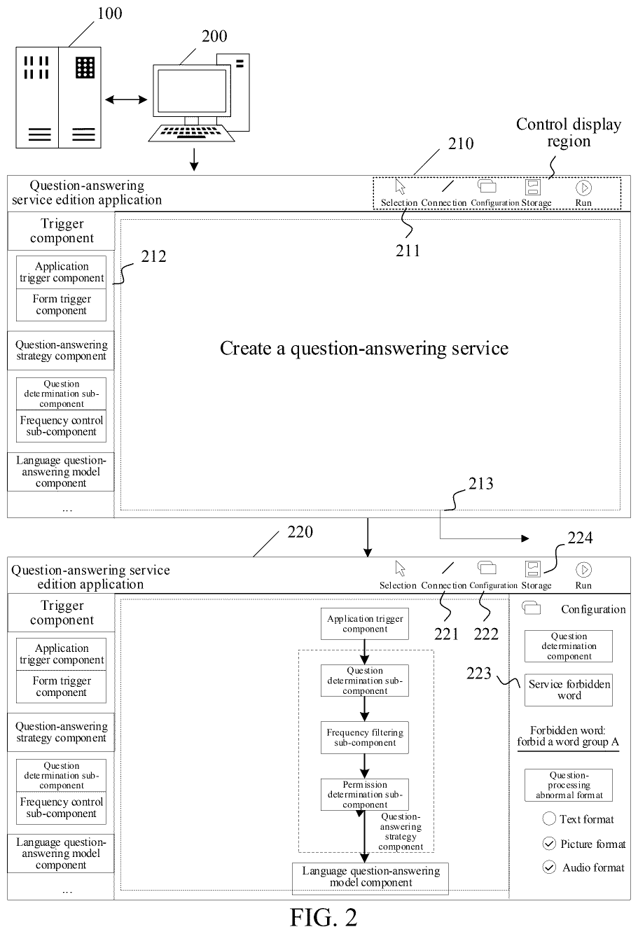

FIG. 2 is a schematic diagram showing a scenario of generating a question-answering service according to an embodiment of this application. A terminal device 200 may be provided with a question-answering service edition application. In an edition interaction page 210 of the question-answering service edition application, the question-answering service edition application may display a functional code encapsulation component set in a component candidate page 212. The functional code encapsulation component set may include a trigger component (such as an application trigger component and a form trigger component), a question-answering strategy component (such as a question determination sub-component and a frequency control sub-component), a plurality of language question-answering model components of different algorithm types, etc.

A user may click a selection control 211, trigger a component selection operation in the question-answering service edition application, and drag a selected functional code encapsulation component in the component candidate page 212 to the question-answering service edition page 213 of the question-answering service edition application. The component candidate page is a page that displays the functional code encapsulation components to be selected, and the selected functional code encapsulation components may be presented and edited in the question-answering service edition page.

The question-answering service edition application in the terminal device 200 may display the trigger component, the question-answering strategy component, and the language question-answering model component that are selected. For example, the terminal device 200 may display the trigger component (including the application trigger component), the question-answering strategy component (including the question determination sub-component, the frequency control sub-component, and the permission determination sub-component) and the language question-answering model component in the edition interaction page 220 of the question-answering service edition application.

The application trigger component may be an initial component of the entire workflow of the running of the question-answering service. When edition in the question-answering service edition application is completed, the question-answering service is formed. When the user accesses the question-answering service, the user inputs the service question into an independent page of the question-answering service, and the terminal device 400 may activate a function provided by the question-answering service through the application trigger component, and invoke the question-answering strategy component in the question-answering service.

The question determination sub-component in the question-answering strategy component is configured to filter the service question that includes a service forbidden word or has a file format of a question-processing abnormal format. The service forbidden word refers to a word that is forbidden from being used in the service question, and may be an illegal word or may be a word that is merely composed of symbols, spaces, etc. and fails to express an actual language meaning. The question-processing abnormal format is specifically set for the selected language question-answering model component. For example, if the selected language question-answering model component may merely process a text message, a file format of the service question that may not be processed by the language question-answering model component, such as a picture and an audio may be set as the question-processing abnormal format. The frequency control sub-component in the question-answering strategy component is configured to filter the service question from a same user that invokes the question-answering service at a frequency over a filtering threshold indicated by the frequency control sub-component. A unit time range of the frequency of invoking the question-answering service may be one hour, one day, or one week, which is not limited herein. The permission determination sub-component in the question-answering strategy component is configured to filter a service question from the user whose questioning permission falls beyond the question permission range.

The edition interaction page 220 of the question-answering service edition application includes a control display region. A connection control 221 is displayed in the control display region. When the user may click the connection control 221, the terminal device 200 may trigger an component arrangement operation in response to the click on the connection control 221, then drag the connection control 221 from the application trigger component to the question determination sub-component in response to the component arrangement operation, create the processing flow connection relationship between the application trigger component and the question determination sub-component, and determine that the question determination sub-component is the functional code encapsulation component of a next flow of the application trigger component. Similarly, at the question determination sub-component, the user may determine that the frequency control sub-component is the functional code encapsulation component of a next flow of the question determination sub-component through the connection control 221. Similarly, it may be determined that the permission determination sub-component is the functional code encapsulation component of a next flow of the frequency control sub-component, and the language question-answering model component is the functional code encapsulation component of a next flow of the permission determination sub-component. Thus, creation of the processing flow connection relationship between the selected functional code encapsulation components is completed.

The control display region of the edition interaction page 220 of the question-answering service edition application may also display a configuration control 222. When the user clicks the configuration control 222, the terminal device 200 may trigger a component configuration operation in response to the click on the configuration control 222. After the component configuration operation is triggered, the terminal device 200 may display the parameter configuration page 223 in the question-answering service edition application in response to the click on the question determination sub-component, and configure the service forbidden word and the question-processing abnormal format of the selected question determination sub-component. The service forbidden word and the question-processing abnormal format may be configured. For example, a forbidden word group A may be set as the service forbidden word, and it may be determined that an image format and an audio format are the question-processing abnormal formats.

The control display region of the edition interaction page 220 of the question-answering service edition application may also display a storage control 224. When the user clicks the storage control 224, the terminal device 200 may trigger a question-answering service confirmation operation in response to the click on the storage control 224. In response to the question-answering service confirmation operation, the terminal device 200 may generate the question-answering service through the question-answering service edition application on the basis of the processing flow connection relationship among the trigger component, the question-answering strategy component, and the language question-answering model component that are selected by the user.

In a specific implementation of this application, when user data involved (such as the service question, the questioning frequency, and the questioning permission) are applied to a specific product or technology in the embodiments described above and below of this application, an approval or consent from the user is required, and collection, use, and processing of relevant data need to comply with relevant laws, regulations and standards of relevant countries and regions.

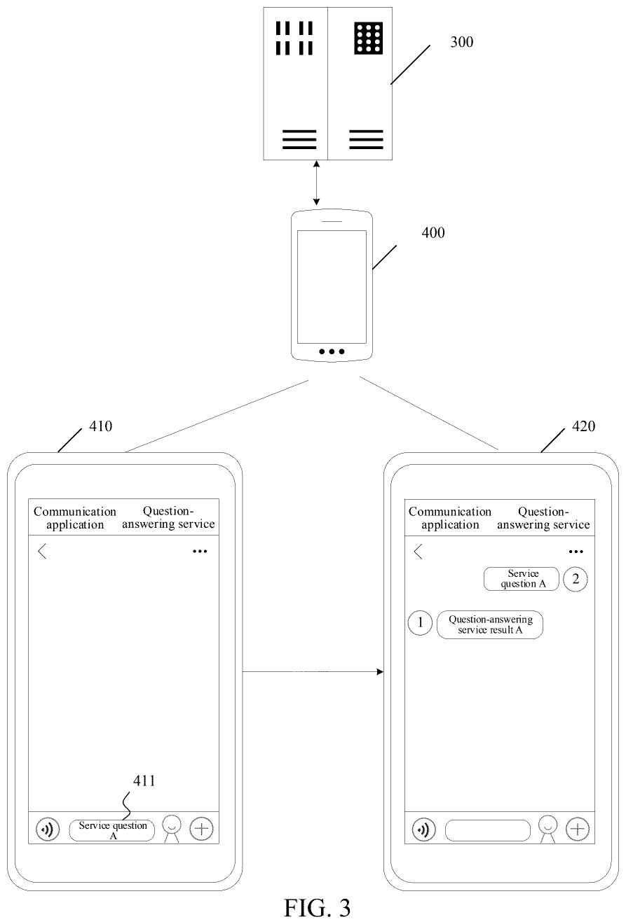

FIG. 3 is a schematic diagram showing a scenario of generating a question-answering service according to an embodiment of this application. A terminal device 400 may be provided with a communication application, and the terminal device 400 may access the question-answering service through the communication application. In a question-answering interaction page 410 of a question-answering service edition application, the terminal device 400 may display a question-answering interaction page in the communication application. A user may input a service question A into the question-answering interaction page. The service question A includes a trigger parameter. If the trigger parameter satisfies a question-answering trigger condition (the question-answering service may be invoked when the user inputs a service question into an independent page of the question-answering service) indicated by a trigger component in the question-answering service, the service question A may be transmitted to a communication server 300 through the trigger component, and the communication server 300 forwards the service question A to a work server 100. The work server 100 processes the service question A through a functional code encapsulation component selected for the question-answering service, obtains a question-answering service result of the service question A, and returns the question-answering service result to the communication server 300. The communication server 300 transmits the question-answering service result to the terminal device 400. As shown in the question-answering interaction page 420 of the question-answering service edition application, the communication application in the terminal device 400 may display, in the question-answering interaction page, a question-answering service result A of the service question A inputted by the user.

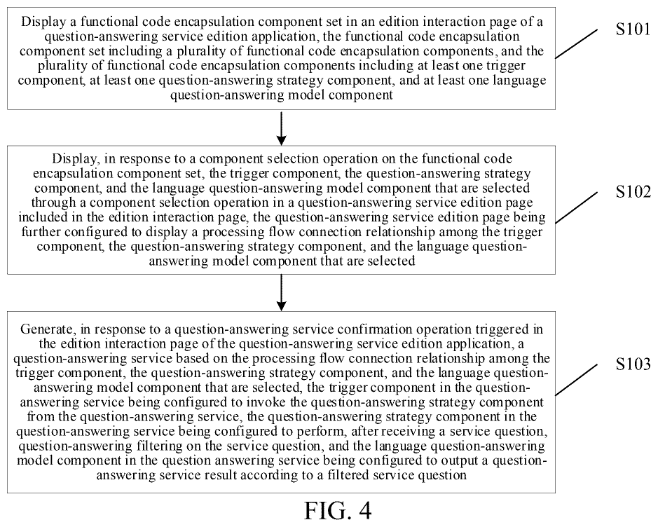

FIG. 4 is a schematic flowchart of a method for generating a question-answering service according to an embodiment of this application. The method for generating a question-answering service may be performed by a computer device, and the computer device may be the terminal device 200 or the work server 100 as shown in FIG. 1. As shown in FIG. 4, the method may include the following operations:

Operation S101: Display a functional code encapsulation component set in an edition interaction page of a question-answering service edition application, the functional code encapsulation component set including a plurality of functional code encapsulation components, and the plurality of functional code encapsulation components including at least one trigger component, at least one question-answering strategy component, and at least one language question-answering model component.

The computer device may display the functional code encapsulation component set in the question-answering service edition application. The functional code encapsulation component set includes one or more trigger components, one or more question-answering strategy components, and one or more language question-answering model components.

Specifically, the computer device may display the functional code encapsulation component set in the edition interaction page of the question-answering service edition application. The functional code encapsulation component set may include a plurality of functional code encapsulation components. The plurality of functional code encapsulation components include the at least one trigger component, further include the at least one question-answering strategy component, and further include the at least one language question-answering model component. The functional code encapsulation component set may further include other functional code encapsulation components, such as a functional code encapsulation component configured to perform message notification, a functional code encapsulation component configured to invoke application programming interfaces (APIs) of other platforms, a functional code encapsulation component configured to terminate a flow, and a functional code encapsulation component configured to perform an idle operation, which is not limited herein in the embodiment of this application. The idle operation is an operation without actual processing, and the computer program is to know which type of operation needs to be done. A case that no operation needs to be performed may be indicated by the idle operation.

The functional code encapsulation component refers to a component that has a functional function and a predefined behavior and attribute. The attribute may include code logic and names, parameters, return values, etc. in the functional code encapsulation component. The functional function may be filled into the functional code encapsulation component by using various pre-programmed program modules and libraries. The trigger component may be configured to measure whether the service question raised by the user satisfies a question-answering trigger condition, and may invoke the question-answering strategy component in the question-answering service when the question satisfies the question-answering trigger condition. The question-answering strategy component is a component for filtering the service question, and may filter the service question that is incapable of being processed by the language question-answering model component. The language question-answering model component may perform semantic identification on a filtered service question, and output a question-answering service result of the service question.

Different trigger components indicate different trigger conditions. For example, the trigger components may include an application trigger component, a form trigger component, a mention trigger component, a switch trigger component, and a cycle trigger component. The question trigger condition of the application trigger component may be that the user invokes the question-answering service by inputting the service question into a one-on-one chat page. The question trigger condition of the form trigger component may be that the user invokes the question-answering service by submitting a form. The question trigger condition of the mention trigger component may be that the user invokes the question-answering service by mentioning (may be through @) the question-answering service (or by representing a specific name of the question-answering service) in the chat. The question trigger condition of the switch trigger component may be that the user invokes the question-answering service by switching from the chat page to the one-on-one chat page of the question-answering service. The question trigger condition of the cycle trigger component question may be that the question-answering service may be automatically invoked per time cycle, work (event) period, etc. without active invocation by the user. For example, the question-answering strategy component in the question-answering service may be invoked cyclically every other day. The question trigger condition of the trigger component may be determined based on different functional functions and specific workflows, which is not limited herein in the embodiment of this application.

Different question-answering strategy components filter the question-answering service by different methods. For example, the question-answering strategy component may include a question determination sub-component, a frequency control sub-component, and a permission determination sub-component. The question determination sub-component may be configured to filter the service question that includes a service forbidden word or has a file format of a question-processing abnormal format. The service forbidden word refers to a word that is forbidden from being used in the service question, and may be an illegal word or may be a word that is merely composed of symbols, spaces, etc. and fails to express an actual language meaning. The question-processing abnormal format is specifically set for the selected language question-answering model component. For example, if the selected language question-answering model component may merely process a text message, a file format of the service question that may not be processed by the language question-answering model component, such as a picture and an audio may be set as the question-processing abnormal format. The frequency control sub-component is configured to filter the service question from a same user that invokes the question-answering service at a frequency over a filtering threshold indicated by the frequency control sub-component. A unit time range of the frequency of invoking the question-answering service may be one hour, one day, or one week, which is not limited herein. The permission determination sub-component is configured to filter a service question from the user whose questioning permission falls beyond the question permission range.

The question-answering strategy component may filter the service question through determination based on various types of logic, and orient the flow to different directions. For example, the service question from the user whose questioning permission falls within the question permission range in the permission determination sub-component may be oriented to the language question-answering model component. The service question from the user whose questioning permission falls beyond the question permission range may be oriented to the functional code encapsulation component that performs an idle operation and the functional code encapsulation component that performs message information on “no questioning permission.”

Algorithm types of language question-answering models created in different language question-answering model components are different. The algorithm types may refer to that training text sets of the language question-answering models come from different vertical fields. For example, the vertical fields may be an e-commerce customer service, a communication chat assistant, and intelligent education question answering. Initial language models and training methods adopted may alternatively be different, such as a recurrent neural network (RNN), and a long short-term memory (LSTM), which is not limited herein in the embodiment of this application.

A training process of the language question-answering model created in the language question-answering model component may be as follows: obtain the training text set, filter the service stop word from the training text set, perform text division on the filtered training text set, and obtain M text fragments; count a number of times of occurrence of each text fragment in the M text fragments, and obtain text frequencies corresponding to the M text fragments, M being a positive integer; obtain an initial language model, and establish a text dictionary of the initial language model based on the M text fragments and the M text frequencies, the text dictionary including word vectors corresponding to the M text fragments; obtain a question-answering sample, and establish a question-answering word vector corresponding to the question-answering sample based on the text dictionary; and train the initial language model based on the question-answering word vector, and obtain the language question-answering model component.

A training process of the language question-answering model in the language question-answering model component may be specifically as follows: obtain a training text set, and filter the service stop word from the training text set; perform text division on the filtered training text set, and obtain M text fragments; count a number of times of occurrence of the M text fragments, and obtain text frequencies corresponding to the M text fragments, M being a positive integer; obtain an initial language model, and establish a text dictionary of the initial language model based on the M text fragments and the M text frequencies, the text dictionary including word vectors corresponding to the M text fragments; and obtain a question-answering sample, establish a question-answering word vector corresponding to the question-answering sample based on the text dictionary, adjust a model parameter of the initial language model based on the question-answering word vector until the initial language model satisfies a model convergence condition, and obtain the language question-answering model component.

Specifically, the computer device may obtain the training text set. The training text set may include a conventional natural corpus (a web page text, a news text, a novel text, etc.), and may further include a technical corpus (such as an educational text) for service needs. The computer device may perform data cleaning on the training text set, re-examine and verify the training text set, delete a repeated training text and a training text having a missing value or an invalid value, and obtain the training text set of data consistency.

The computer device may remove the service stop word from the training text set after the data cleaning. The service stop word refers to a word or a punctuation mark that is common in a natural language text but have no specific meaning in semantic analysis. For example, in Chinese texts, the service stop word may include: “de,” “le,” “shi,” “zai” and “you” in pinyin. In English texts, the service stop word may include: “the,” “a,” “an,” and “in.”

The computer device may perform text division (may also be referred to as word segmentation) on the training text set with the service stop word removed. The text division may adopt a rule matching method or a probability matching method. With the text division being performed, by the probability matching method, on a training text C in a training text set A as an example, there are word segmentation solutions S for the text division on the training text C. A task of the text division is to find, from the word segmentation solutions S, a solution through which an occurrence probability P(S|C) of a segmented word in the training text set A is maximum. According to Bayes formula, the probability P(S|C) may be computed by Formula (1) as follows:

$${argmax}_{s ∈ c} P ( S \vert C ) = \frac{P ( C \vert S ) P ( S )}{P ( C )} \qquad Formula ( 1 )$$

In the formula, P (C) denotes a probability that the training text C occurs in the training text set A, P (C|S) denotes a probability that the training text C is lemmatized by the word segmentation solution, the word segmentation solution S divides the training text set into M text fragments (a text fragment W₁, text fragmentW₂, . . . , text fragmentW_{M}), then P(S)=E_{M=i} P(Wᵢ), and P(Wᵢ) denotes a ratio of a number of times of occurrence of the text fragment Wᵢ in the training text set A to a total number of words in the training text set A.

The computer device may count the number of times of the occurrence of the text fragment Wᵢ after the text division in the training text set A, and obtain the text frequencies corresponding to the M text fragments. The text frequency may also be the probability of the text fragment in the training text set A, that is P(Wᵢ).

The computer device may establish the text dictionary of the initial language model based on the M text fragments and the M text frequencies. The text dictionary may include word vectors corresponding to the M text fragments. The word vector is a model-acceptable numerical representation form converted from the text data, and may also include a position of the text fragment Wᵢ in the training text C, a number of the text fragment Wᵢ, and a lemmatized word form of the text fragment Wᵢ. The lemmatized word form refers to an original form of the text fragment lemmatized in consideration of a context and a part of speech of the text fragment. For example, “have eaten” and “finish eating” to “eat.”

The initial language model may be a neural network model, such as the recurrent neural network and the long short-term memory. The initial language model may be composed of a plurality of hidden layers and an output layer.

The computer device may set a size and a learning rate of the hidden layer of the initial language model. The learning rate refers to a gradient descent step size amplitude determined according to a model convergence condition, and affects a model convergence speed. The gradient is configured for adjusting a parameter value of the hidden layer in the initial language model in the gradient descent.

The computer device may convert the word vector in the text dictionary into a question-answering training sequence and a question-answering target sequence of the initial language model. The question-answering training sequence and the question-answering target sequence are also question-answering samples.

The computer device may input the question-answering training sequence into the initial language model, train according to a predefined loss function, and obtain a question-answering predicted result outputted by the initial language model at the output layer. The loss function may be a cross entropy loss function, a mean squared error loss function, etc., which is not limited herein.

The computer device may adjust the parameter value of the hidden layer of the initial language model according to the computation gradient, so as to minimize the loss function. When the question-answering predicted result and the question-answering target sequence of the initial language model satisfy the preset model convergence condition, the language question-answering model component is obtained. The model convergence condition refers to that a performance metric between the question-answering predicted result and the question-answering target sequence is lower than a preset value, and the performance metric may include accuracy, precision, recall, etc.

In a training process of the initial language model, dropout (a hidden layer in the neural network model, configured to randomly set some neurons as 0 in the training process so as to reduce over-fitting risk of the neural network model), batch normalization (by normalizing each small batch of inputs, an average and a variance of each feature in the training data may be made close to 0 and 1 respectively, so as to speed up the training process and improve stability and generalization of the neural network model), and other skills may be used to improve a training effect of the model.

Operation S102: Display, in response to a component selection operation on the functional code encapsulation component set, the trigger component, the question-answering strategy component, and the language question-answering model component, that are selected through the component selection operation, in a question-answering service edition page included in the edition interaction page, the question-answering service edition page being further configured to display a processing flow connection relationship among the trigger component, the question-answering strategy component, and the language question-answering model component that are selected.

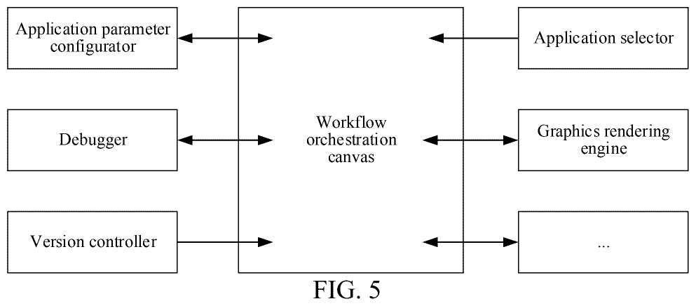

Specifically, FIG. 5 is a schematic diagram showing a scenario of generating a question-answering service according to an embodiment of this application. As shown in FIG. 5, the question-answering service edition application may mainly include components such as a workflow orchestration canvas, an application selector, a graphics rendering engine, an application parameter configurator, a debugger, and a version controller.

The workflow orchestration canvas may be configured to bear a display effect of the functional code encapsulation component. The application selector may locate the functional code encapsulation component in the question-answering service edition page when dragging the functional code encapsulation component, so as to guarantee that the user selects a correct functional code encapsulation component. The graphics rendering engine may render the functional code encapsulation components and the connection line (the processing flow connection relationship) between the functional code encapsulation components through graphical presentation. The trigger component may be denoted by a circular module. A diamond module mainly denotes the question-answering strategy component. A square module denotes a specific application action, such as transmitting a message, invoking an API of other platforms, and terminating a flow and an idle operation. The application parameter configurator may graphically configure the functional code encapsulation component, and input relevant configuration information into the application parameter configurator, such as an instance template identifier below. The debugger may run the question-answering service, and generate a performance log table below, so as to perform statistics on a running state and service quality quantification data of the question-answering service through log information. The version controller may save different versions of the question-answering service. Through the version controller, a switch can be performed between different versions of the question-answering service, and information of a version change each time can be recorded.

The computer device may drag the selected functional code encapsulation components into the question-answering service edition page of the question-answering service edition application, or may select a required functional code encapsulation component at first, and directly create the selected functional code encapsulation component at a designated position of the question-answering service edition page of the question-answering service edition application in response to the component selection operation on the functional code encapsulation component set by the question-answering service edition application (through the application selector shown in FIG. 5).

The computer device may create the processing flow connection relationship between the functional code encapsulation components, for example, the processing flow connection relationship between the trigger component and the question-answering strategy component, through the connection line in response to the component arrangement operation on the question-answering service edition application. The trigger component may be connected to the question-answering strategy component, and it may be determined that the question-answering strategy component is the functional code encapsulation component of a next flow of the trigger component.

In an embodiment, the method for generating a question-answering service further includes the following operations: create, in response to a first component arrangement operation on the functional code encapsulation components selected from the question-answering service edition page, the processing flow connection relationship between the trigger component and the question-answering strategy component that are selected; determine that the selected trigger component is the functional code encapsulation component configured to perform an initial flow of the question-answering service, and determine that the selected question-answering strategy component is the functional code encapsulation component configured to perform a next flow of the trigger component based on the processing flow connection relationship between the trigger component and the question-answering strategy component that are selected; create, in response to a second component arrangement operation on the functional code encapsulation components selected from the question-answering service edition page, the processing flow connection relationship between the question-answering strategy component and the language question-answering model component that are selected; and determine, based on the processing flow connection relationship between the question-answering strategy component and the language question-answering model component that are selected, that the selected language question-answering model component is the functional code encapsulation component configured to perform a next flow of the question-answering strategy component.

In some embodiments, the computer device may perform, in response to the first component arrangement operation between the trigger component and the question-answering strategy component and the second component arrangement operation between the question-answering strategy component and the language question-answering model component, the following arrangement process: create, in response to the first component arrangement operation on the functional code encapsulation components selected from the question-answering service edition page by the question-answering service edition application, the processing flow connection relationship between the trigger component and the question-answering strategy component that are selected, and determine that the selected trigger component is the functional code encapsulation component configured to perform the initial flow of the question-answering service, and determine that the selected question-answering strategy component is the functional code encapsulation component configured to perform the next flow of the trigger component based on the processing flow connection relationship between the trigger component and the question-answering strategy component that are selected; and create, in response to the second component arrangement operation on the functional code encapsulation components selected from the question-answering service edition page by the question-answering service edition application, the processing flow connection relationship between the question-answering strategy component and the language question-answering model component that are selected, and determine, based on the processing flow connection relationship between the question-answering strategy component and the language question-answering model component that are selected, that the selected language question-answering model component is the functional code encapsulation component configured to perform the next flow of the question-answering strategy component.

Specifically, the computer device may connect the trigger component to the question-answering strategy component, create the processing flow connection relationship between the trigger component and the question-answering strategy component that are selected, and determine that the selected trigger component is the functional code encapsulation component configured to perform the initial flow of the question-answering service, and determine that the selected question-answering strategy component is the functional code encapsulation component configured to perform the next flow of the trigger component in response to the first component arrangement operation between the trigger component and the question-answering strategy component that are selected from the question-answering service edition page by the question-answering service edition application.

Similarly, the computer device may also connect the question-answering strategy component to the language question-answering model component, create the processing flow connection relationship between the question-answering strategy component and the language question-answering model component that are selected, and determine that the selected language question-answering model component is the functional code encapsulation component configured to perform the next flow of the question-answering strategy component in response to the second component arrangement operation between the question-answering strategy component and the language question-answering model component that are selected from the question-answering service edition page by the question-answering service edition application. The question-answering strategy component may include a question determination sub-component, a frequency control sub-component, and a permission determination sub-component.

In an embodiment, the question-answering strategy component includes the question determination sub-component, the frequency control sub-component, and the permission determination sub-component, and the method for generating a question-answering service further includes: create, in response to a third component arrangement operation on the question determination sub-component and the frequency control sub-component that are selected from the question-answering service edition page, a processing flow connection relationship between the question determination sub-component and the frequency control sub-component that are selected; determine that the selected question determination sub-component is the functional code encapsulation component configured to perform an initial flow of the question-answering strategy component, and determine that the selected frequency control sub-component is the functional code encapsulation component configured to perform a next flow of the question determination sub-component based on the processing flow connection relationship between the question determination sub-component and the frequency control sub-component that are selected; create, in response to a fourth component arrangement operation on the frequency control sub-component and the permission determination sub-component that are selected from the question-answering service edition page, a processing flow connection relationship between the frequency control sub-component and the permission determination sub-component that are selected; and determine, based on the processing flow connection relationship between the frequency control sub-component and the permission determination sub-component that are selected, that the selected permission determination sub-component is the functional code encapsulation component configured to perform a next flow of the frequency control sub-component.

In some embodiments, a process of arranging the question determination sub-component, the frequency control sub-component, and the permission determination sub-component by the computer device may be as follows: create, in response to the third component arrangement operation on the question determination sub-component and the frequency control sub-component that are selected from the question-answering service edition page by the question-answering service edition application, the processing flow connection relationship between the question determination sub-component and the frequency control sub-component that are selected, and determine that the selected question determination sub-component is the functional code encapsulation component configured to perform the initial flow of the question-answering strategy component, and determine that the selected frequency control sub-component is the functional code encapsulation component configured to perform the next flow of the question determination sub-component based on the processing flow connection relationship between the question determination sub-component and the frequency control sub-component that are selected; and create, in response to the fourth component arrangement operation on the frequency control sub-component and the permission determination sub-component that are selected from the question-answering service edition page by the question-answering service edition application, the processing flow connection relationship between the frequency control sub-component and the permission determination sub-component that are selected, and determine, based on the processing flow connection relationship between the frequency control sub-component and the permission determination sub-component that are selected, that the selected permission determination sub-component is the functional code encapsulation component configured to perform the next flow of the frequency control sub-component.

Specifically, the computer device may connect the question determination sub-component to the frequency control sub-component, create the processing flow connection relationship between the question determination sub-component and the frequency control sub-component that are selected, determine that the selected question determination sub-component is the functional code encapsulation component configured to perform the initial flow of the question-answering strategy component, and determine that the selected frequency control sub-component is the functional code encapsulation component configured to perform the next flow of the question determination sub-component in response to the third component arrangement operation on the question determination sub-component and the frequency control sub-component that are selected from the question-answering service edition page by the question-answering service edition application.

Similarly, the computer device may connect the frequency control sub-component to the permission determination sub-component, create the processing flow connection relationship between the frequency control sub-component and the permission determination sub-component that are selected, and determine the selected permission determination sub-component is the functional code encapsulation component configured to perform the next flow of the frequency control sub-component in response to the fourth component arrangement operation on the frequency control sub-component and the permission determination sub-component that are selected from the question-answering service edition page by the question-answering service edition application.

The question-answering service edition application in the computer device may display the trigger component, the question-answering strategy component, and the language question-answering model component that are selected, and display the processing flow connection relationship among the trigger component, the question-answering strategy component, and the language question-answering model component that are selected in the question-answering service edition page.

In an embodiment, the method for generating a question-answering service further includes the following operations: display, in response to a component configuration operation on the functional code encapsulation component selected from the question-answering service edition page, a plurality of instance template identifiers in the parameter configuration page in the edition interaction page; determine a target instance template identifier from the plurality of instance template identifiers; and update the selected functional code encapsulation component in the question-answering service edition page based on the target instance template identifier, the instance template identifier being configured to determine a functional function corresponding to the functional code encapsulation component, and the functional function being configured to perform function processing on the service question.

In some embodiments, the computer device may configure, in response to the component configuration operation on the functional code encapsulation component, in a process as follows: display, in response to the component configuration operation on the functional code encapsulation component selected from the question-answering service edition page by the question-answering service edition application, the plurality of instance template identifiers in the parameter configuration page of the question-answering service edition application, and determine the target instance template identifier from the plurality of instance template identifiers, the plurality of instance template identifiers including the target instance template identifier; and update the selected functional code encapsulation component in the question-answering service edition page of the question-answering service edition application based on the target instance template identifier; the instance template identifier being configured to determine the functional function corresponding to the functional code encapsulation component, and the functional function being configured to perform the function processing on the service question.

Specifically, the computer device may display, in response to the component configuration operation (through the application parameter configurator shown in FIG. 5) on the functional code encapsulation component, the plurality of instance template identifiers in the parameter configuration page of the question-answering service edition application. The instance template identifier may be configured to determine the functional function corresponding to the functional code encapsulation component, and the functional code encapsulation component performs the function processing on the service question through the functional function. The computer device may select a required instance template identifier from the plurality of instance template identifiers, and update the functional code encapsulation component through the selected instance template identifier. For example, in the cycle trigger component, select a time trigger template identifier or an event trigger template identifier. For example, from a cycle trigger component, a time trigger template identifier or an event trigger template identifier is selected. For example, from a cycle trigger, the time trigger template identifier is selected, and the instance parameter is modified to 86400 seconds, that is, one day. Then, the question-answering service is triggered cyclically every other day. The event trigger template identifier is selected, and the instance parameter (event) is modified to a temperature exceeding 36° C. Then, the question-answering service is automatically triggered when the temperature exceeds 36° C.

In some embodiments, the computer device may also configure an instance name, an instance name of a previous flow node, an instance name of a next flow node, the instance parameter, etc. of the functional code encapsulation component in the parameter configuration page of the question-answering service edition application. The instance name and the instance name of the next flow node may jointly represent the processing flow connection relationship, and the instance parameter may be an auxiliary parameter of the functional function corresponding to the instance template identifier.

The computer device may modify the processing flow connection relationship between the functional code encapsulation component and the functional code encapsulation component of the previous flow node or the functional code encapsulation component of the next flow node by modifying the instance name of the previous flow node or the instance name of the next flow node. The computer device may modify the instance parameter. For example, from the cycle trigger, the time trigger template identifier is selected, and the instance parameter is modified to 86400 seconds, that is, one day. Then, the question-answering service is triggered cyclically every other day.

The computer device may update the functional code encapsulation component through the selected instance template identifier (or the determined instance name, the instance name of the previous flow node selected, the instance name of the next flow node selected, or the determined instance parameter) in the question-answering service edition page of the question-answering service edition application.

In an embodiment, the method for generating a question-answering service further includes the following operations: configure, in response to a first component configuration operation on the question determination sub-component selected from the question-answering service edition page, a service forbidden word and a question-processing abnormal format of the selected question determination sub-component in a parameter configuration page in the edition interaction page; configure, in response to a second component configuration operation on the frequency control sub-component selected from the question-answering service edition page, a frequency threshold of the selected frequency control sub-component in the parameter configuration page; and configure, in response to a third component configuration operation on the permission determination sub-component selected from the question-answering service edition page, a question permission range of the selected permission determination sub-component in the parameter configuration page.

In some embodiments, the computer device may configure, in response to the first component configuration operation on the question determination sub-component, the second component configuration operation on the frequency control sub-component, and the third component configuration operation on the permission determination sub-component in the question-answering strategy component, in a process as follows: configure, in response to the first component configuration operation on the question determination sub-component selected from the question-answering service edition page by the question-answering service edition application, the service forbidden word and the question-processing abnormal format of the selected question determination sub-component in the parameter configuration page of the question-answering service edition application; configure, in response to the second component configuration operation on the frequency control sub-component selected from the question-answering service edition page by the question-answering service edition application, the frequency threshold of the selected frequency control sub-component in the parameter configuration page; and configure, in response to the third component configuration operation on the permission determination sub-component selected from the question-answering service edition page by the question-answering service edition application, the question permission range of the selected permission determination sub-component in the parameter configuration page.

Specifically, The computer device may configure, in response to the first component configuration operation on the question determination sub-component selected from the question-answering service edition page by the question-answering service edition application, the service forbidden word and the question-processing abnormal format of the selected question determination sub-component in the parameter configuration page of the question-answering service edition application.

Since the question-answering service requires high computation cost, the computer device may choose to perform primary-layer validity determination on the service questions inputted by the user through the question determination sub-component, and filter some typical invalid questions, for example, the service question that includes the service forbidden word or has the file format of the question-processing abnormal format. The filtered service question is introduced into an idle operation without any processing.

The question-processing abnormal format is specifically set for the selected language question-answering model component. For example, if the selected language question-answering model component may merely process a text message, a file format of the service question that may not be processed by the language question-answering model component, such as a picture and an audio may be set as the question-processing abnormal format. The service forbidden word may refer to a word that is forbidden from being used in the service question, an illegal word, or a user-defined word.

In some embodiments, the question determination sub-component may also filter the service question that merely includes the trigger parameter (for example, in a switch trigger component, the user switches to the one-on-one chat page, but does not input the service question), other service questions that have no service question content (for example, empty messages that lose service question contents during transmission), and the service questions that have no actual natural semantics, such as the service questions that are merely composed of a symbol, an emoticon (such as emoji/s), a space, a special character (such as color value #66ccff, markup language <table>).

The computer device may configure, in response to the second component configuration operation on the frequency control sub-component selected from the question-answering service edition page by the question-answering service edition application, the frequency threshold of the selected frequency control sub-component in the parameter configuration page, control the questioning frequency (the frequency of invoking the question-answering service) of the user, and filter the service question raised by a same user at a questioning frequency over the filtering threshold set by the frequency control sub-component.

The unit time range of the questioning frequency may be one hour, one day, or one week, which is not limited herein. For example, the unit time range may be set as 86400 seconds, that is, 1 day. A number of times of questioning is set as 100. That is, the same user is allowed to invoke the question-answering service 100 times one day. After the user invokes the question-answering service more than 100 times, a subsequently invoked service question is filtered.

The computer device configure, in response to the third component configuration operation on the permission determination sub-component selected from the question-answering service edition page by the question-answering service edition application, the question permission range of the selected permission determination sub-component in the parameter configuration page service question, and filter the service question from the user whose questioning permission falls beyond the question permission range.

The user invoking the question-answering service may be compared with a built-in user list. If the user invoking the question-answering service falls beyond the built-in user list, the service question of the user invoking the question-answering service is filtered, and a reminder of no questioning permission is returned to the user.

Operation S103: Generate, in response to a question-answering service confirmation operation triggered in the edition interaction page of the question-answering service edition application, the question-answering service based on the processing flow connection relationship among the trigger component, the question-answering strategy component, and the language question-answering model component that are selected, the trigger component in the question-answering service being configured to invoke the question-answering strategy component from the question-answering service, the question-answering strategy component in the question-answering service being configured to perform, after receiving a service question, question-answering filtering on the service question, and the language question-answering model component in the question-answering service being configured to output a question-answering service result according to a filtered service question.

Specifically, the computer device may generate, in response to the question-answering service confirmation operation in the question-answering service edition application, the question-answering service based on the processing flow connection relationship among the trigger component, the question-answering strategy component, and the language question-answering model component that are selected. The question-answering service refers to the service generating question answering through the language question-answering model component. The generated question-answering service may be directly accessed and used in an application supported by the question-answering service edition application. For example, the question-answering service edition application supports direct embedding of the question-answering service in the communication application, and the question-answering service may be accessed in the communication application.

In an embodiment, the method for generating a question-answering service further includes the following operations: create a performance log table for the question-answering service based on the trigger component, the question-answering strategy component, and the language question-answering model component that are selected; record log information of the functional code encapsulation component in the question-answering service through the performance log table; perform statistics on a running state and service quality quantification data of the question-answering service according to the log information; and adjust at least one of the trigger component, the question-answering strategy component, the language question-answering model component, or the processing flow connection relationship based on the running state and the service quality quantification data of the question-answering service.

In some embodiments, the computer device may display the log information of the question-answering service during running, and adjust the question-answering service based on the log information. A process of displaying the log information of the question-answering service during running may be as follows: create the performance log table for the question-answering service based on the trigger component, the question-answering strategy component, and the language question-answering model component that are selected, and record the log information of the functional code encapsulation component in the question-answering service through the performance log table; display the log information of the question-answering service during running through the performance log table, perform the statistics on the running state and the service quality quantification data of the question-answering service according to the log information, and adjust at least one of the trigger component, the question-answering strategy component, the language question-answering model component, or the processing flow connection relationship based on the running state and the service quality quantification data of the question-answering service.

Specifically, the computer device may create the performance log table for the question-answering service based on the trigger component, the question-answering strategy component, and the language question-answering model component that are selected, and record the log information of the functional code encapsulation component in the question-answering service through the performance log table. The performance log table may also include a log level and a log content classification, and the log level may be as shown in Table 1:

TABLE 1

| Level | Description |
|---|---|
| ERROR | The ERROR log is an error log level, and indicates that the |
| | question-answering service has a very serious failure that |
| | directly leads to a failure to work normally |
| WARN | The WARN log is an abnormal log level, and indicates that |
| | the question-answering service triggers an abnormal process |
| | during running, but such an abnormal process does not affect |
| | normal work of the question-answering service, and a service |
| | flow in a next stage may be performed normally. The log |
| | usually indicates that the question-answering service has |
| | particular running risk, and probably has a running failure. |
| INFO | The INFO log is a record log level, usually records key |
| | information of the question-answering service, and keeps |
| | key running data of the question-answering service during |
| | normal work. |
| DEBUG | The DEBUG log is a debugging log level, mainly records |
| | various types of detailed running information of the question- |
| | answering service, plays a role of debugging the system, and |
| | includes parameter details, debugging details related |
| | information, running return information, and other |
| | information. |

The log content classification may be shown in Table 2:

TABLE 2

| Classification | Description |
|---|---|
| Configuration | Record addition, deletion, and configuration |
| log | modification behaviors of the user |
| Detection log | Record a detection behavior of system running |
| Warning log | Record warning information of system running |
| Running log | Record a behavior during background running |
| | of the entire system |

The computer device may display the log information of the question-answering service during running through the performance log table, and perform the statistics on the running state and the service quality quantification data of the question-answering service according to the log information. For example, the user configures the cycle trigger component of the question-answering service, updates the selected time trigger template identifier to the event trigger template identifier, but fails to configure a trigger event (that is, an instance parameter corresponding to the event trigger template identifier), resulting in that the cycle trigger component may not invoke the question-answering service. The performance log table may record the log level of the log information as ERROR and the log content classification as the configuration log, and record the modification behavior of the user in detail. The service quality quantification data may be an occurrence rate of the error log level, an error rate of the question-answering service result, etc., which is not limited herein.

The computer device may adjust the trigger component, the question-answering strategy component, and the language question-answering model component in the question-answering service, the processing flow connection relationship among the components described above, the instance template identifier, the instance parameter, etc. based on the running state and the service quality quantification data of the question-answering service. Thus, work errors and manual intervention can be reduced, and accuracy and consistency of the question-answering service can be improved. For example, the running state of the question-answering service reflects overload, and then the frequency threshold of the frequency control sub-component in the question-answering strategy component may be adjusted and increased. Thus, the running load of the question-answering service is reduced, and the service quality quantification data of the question-answering service are improved.

According to the embodiment of this application, various functional code encapsulation components supporting independent deployment can be provided, the functional code encapsulation components can be accessed flexibly, and the question-answering service can be generated based on the processing flow connection relationship between the functional code encapsulation components selected by the user. The question-answering service generally includes three categories of the trigger component, the question-answering strategy component, and the language question-answering model component, but fixed functional code encapsulation components and processing flow connection relationship between the functional code encapsulation components are not adopted. The user can flexibly select the required functional code encapsulation components according to the service requirement, adjust the processing flow connection relationship among the components, and generate the question-answering service that satisfies the service requirement.

In the embodiment of this application, the functional code encapsulation component set is displayed in the question-answering service edition application. The functional code encapsulation component set includes the at least one trigger component, the at least one question-answering strategy component, and the at least one language question-answering model component. In response to the component selection operation on the functional code encapsulation component set by the question-answering service edition application, the trigger component, the question-answering strategy component, and the language question-answering model component that are selected are displayed in the question-answering service edition page of the question-answering service edition application. The question-answering service edition page is further configured to display the processing flow connection relationship among the trigger component, the question-answering strategy component, and the language question-answering model component that are selected. In response to the question-answering service confirmation operation in the question-answering service edition application, the question-answering service is generated based on the processing flow connection relationship among the trigger component, the question-answering strategy component, and the language question-answering model component that are selected. The trigger component in the question-answering service is configured to invoke the question-answering service. The question-answering strategy component in the question-answering service is configured to perform question-answering filtering on the service question. The language question-answering model component in the question-answering service is configured to output the question-answering service result according to the filtered service question. Various functional code encapsulation components supporting independent deployment can be provided, the functional code encapsulation components can be accessed flexibly, and the question-answering service can be generated based on the processing flow connection relationship between the functional code encapsulation components selected by the user. In this way, the user without professional programming knowledge can develop the question-answering service through the visual functional code encapsulation components and the processing flow connection relationships instead of writing codes. Thus, development production efficiency and universality of the question-answering service are improved, and development cost and implementation error rates are reduced.

In an embodiment, the process of accessing the question-answering service in the communication application may be specifically as follows: display a question-answering interaction page of the question-answering service in a communication application, and obtain a service question inputted into the question-answering interaction page, the service question including a trigger parameter; invoke the question-answering strategy component in the question-answering service through the trigger component if the trigger parameter satisfies a question-answering trigger condition indicated by the trigger component; filter the service question through the question-answering strategy component in the question-answering service, and obtain a filtered service question; perform question-answering identification on the filtered service question through the language question-answering model component in the question-answering service, and output the question-answering service result; and display the question-answering service result of the service question in the question-answering interaction page.

In the embodiment of this application, the pre-edited functional code encapsulation component is used, and the question-answering service is accessed in the communication application, which is efficient, convenient, low in development cost and low in implementation error rate.

In an embodiment, the method for generating a question-answering service further includes the following operations: obtain a performance record table of the question-answering service, the performance record table including an instance template identifier; and the operations of performing question-answering identification on the filtered service question through the language question-answering model component in the question-answering service, and outputting the question-answering service result include: determine that the filtered service question is an output data variable of the trigger component, and determine that the output data variable of the trigger component is an input data variable of the question-answering strategy component; determine a functional function corresponding to the question-answering strategy component based on the instance template identifier, perform function processing on the input data variable of the question-answering strategy component through the functional function corresponding to the question-answering strategy component, and obtain an output data variable of the question-answering strategy component; determine that the output data variable of the question-answering strategy component is an input data variable of the language question-answering model component; determine a functional function corresponding to the language question-answering model component based on the instance template identifier; perform function processing on the input data variable of the language question-answering model component through the functional function corresponding to the language question-answering model component, and obtain an output data variable of the language question-answering model component; and determine that the output data variable of the language question-answering model component is the question-answering service result.

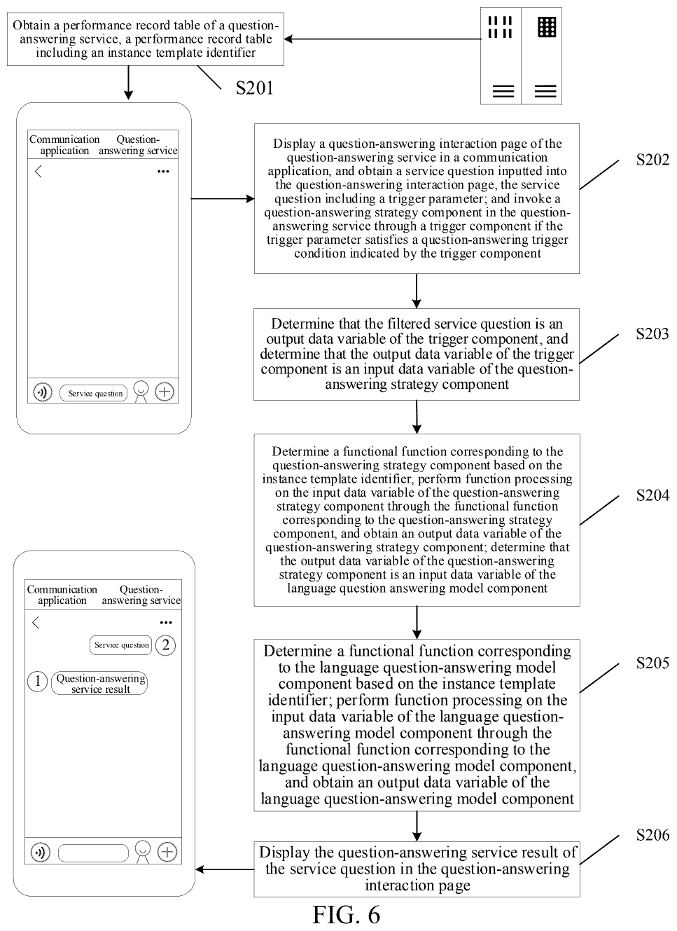

FIG. 6 is a schematic flowchart showing accessing a question-answering service in a communication application according to an embodiment of this application. The question-answering service is accessed in the communication application by the computer device. The computer device may be the terminal device 400 or the communication server 300 as shown in FIG. 1. As shown in FIG. 6, the method may include the following operations:

Operation S201: Obtain performance record table of the question-answering service, the performance record table including an instance template identifier.

Specifically, after the question-answering service is edited, the computer device may create the performance record table for the question-answering service based on component information of the trigger component, the question-answering strategy component, and the language question-answering model component that are selected by the question-answering service. To be specific, domain specific language (DSL) Json structure represented by the functional code encapsulation component is saved into a background database. When the trigger component invokes the question-answering strategy component, the computer device may read the performance record table to complete performing of the question-answering service.

The component information may include an instance name, an instance name of a next flow node, an instance parameter, an instance name of a previous flow node, and an instance template identifier. The instance name and the instance name of the next flow node or the instance name of the previous flow node may represent the processing flow connection relationship. The question-answering strategy component may include a question determination sub-component, a frequency control sub-component, and a permission determination sub-component. The DSL Json is a fast and lightweight JavaScript object notation (JSON) parsing library. The DSL Json supports basic JSON types, such as a number, a string, an array, and an object.

For example, a record of the cycle trigger component by the performance record table may be as shown in Table 3:

TABLE 3

| Component information | Content |
|---|---|
| Instance name | Cycle trigger component |
| Instance template identifier | Time trigger template |
| | identifier |
| Instance parameter | 86400 seconds |
| Instance name of a previous | None |
| flow node | |
| Instance name of a next flow | Question determination sub- |
| node | component |

The computer device may obtain the input data variable and the output data variable of the functional function corresponding to the functional code encapsulation component based on the instance name in the performance record table and may replace the input data variable and the output data variable with corresponding data (such as the service question) based on the performance record table when invoking the question-answering service.

The input data variable refers to an input into the functional code encapsulation component during a processing flow, and the output data variable refers to an output by the functional code encapsulation component during the processing flow.

Operation S202: Display a question-answering interaction page of the question-answering service in a communication application, and obtain a service question inputted into the question-answering interaction page, the service question including a trigger parameter; and invoke the question-answering strategy component in the question-answering service through the trigger component if the trigger parameter satisfies a question-answering trigger condition indicated by the trigger component.

The computer device may display the question-answering interaction page in the communication application, and input the service question into the question-answering interaction page. The service question includes the trigger parameter. The question-answering strategy component in the question-answering service may be invoked through the trigger component if the trigger parameter satisfies the question-answering trigger condition indicated by the trigger component.

Specifically, the computer device may display the question-answering interaction page in the communication application, and the user inputs the service question into the question-answering interaction page. The service question may include the trigger parameter. The trigger parameter refers to a parameter carried when the user transmits the service question.

The service question may also include a prompt. The prompt may be a word or a sentence designed according to demand from the user and an application scenario. For example, the service question of “what to eat today” may include prompts such as “lunch,” “Chinese food,” and “takeout.” The prompt also the lemmatized word form (including contextual information and semantic information) used by the initial language model during training in operation S101 of the embodiment of FIG. 4.

If the trigger parameter satisfies the question-answering trigger condition indicated by the trigger component in the question-answering service, the computer device may activate a function provided by the question-answering service through the trigger component, and invoke the question-answering strategy component in the question-answering service. The question-answering service refers to the service generating question answering through the language question-answering model component.

In some embodiments, the computer device may encrypt the service question invoking the question-answering strategy component in the question-answering service, and start the initial flow of the question-answering service. The process may be as follows: display the question-answering interaction page of the question-answering service in the communication application, and obtain the service question inputted into the question-answering interaction page, the service question including the trigger parameter; and obtain a message credential through the trigger component if the trigger parameter satisfies a question-answering trigger condition indicated by the trigger component; transmit the service question and the message credential to a communication server, cause the communication server to encrypt the service question according to the message credential, and obtain an encrypted ciphertext; and transmit the encrypted ciphertext to a work server, the message credential being further stored in the work server, the work server being configured to decrypt, with the stored message credential, the encrypted ciphertext to obtain the service question, and the work server being further configured to output, through the question-answering service, the question-answering service result corresponding to the service question.

Specifically, the computer device may encrypt the service question invoking the question-answering strategy component in the question answering and start the initial flow of the question-answering service. The process may be as follows: display the question-answering interaction page in the communication application, and input the service question into the question-answering interaction page, the service question including the trigger parameter; and transmit, through the trigger component, the service question and the message credential to a communication server corresponding to the communication application if the trigger parameter satisfies the question-answering trigger condition indicated by the trigger component, cause the communication server to encrypt the service question according to the message credential, obtain the encrypted ciphertext, and transmit the encrypted ciphertext to a work server corresponding to the question-answering service edition application, the message credential being further stored in the work server, the work server being configured to decrypt, with the stored message credential, the encrypted ciphertext to obtain the service question, and the work server being further configured to output, through the question-answering service, the question-answering service result corresponding to the service question.

Specifically, Specifically, the work server may encapsulate the question-answering service, and invoke the question-answering service by providing an interface to the outside, for example, by constructing a network request (a hypertext transfer protocol (HTTP) request). The computer device may write the service question to the request body (a body part) of a network request message, and the work server returns a final question-answering service result to the computer device through a message (an HTTP response).

The computer device may establish the question-answering service in the communication application, and obtain the message credential of the question-answering service. The message credential may include a callback address (webhook), an encryption token, and a communication key (an adaptive communication environment key (ACE key)) of the work server. The computer device may set a callback address of the question-answering service as the callback address of the work server in the communication application.

The computer device may display the question-answering interaction page in the communication application, and the user may input the service question into the question-answering interaction page. The service question may include the trigger parameter. The trigger parameter refers to the parameter carried when the user transmits the service question.

The computer device may transmit, through the trigger component, the service question and the message credential to the communication server corresponding to the communication application if the trigger parameter satisfies the question-answering trigger condition indicated by the trigger component.

The communication server may encrypt the received service question through the encryption token and the communication key, and obtain the encrypted ciphertext. The communication server may transmit the encrypted ciphertext to the work server.

The work server may receive the encrypted ciphertext through the trigger component, decrypt the encrypted ciphertext by using the encryption token and the communication key that are stored in the work server, obtain the service question, and invoke the question-answering strategy component in the question-answering service. The work server may filter the service question through the question-answering strategy component in the question-answering service, perform question-answering identification on the filtered service question through the language question-answering model component in the question-answering service, output the question-answering service result, transmit the question-answering service result to the computer device, and display the question-answering service result in the question-answering interaction page in the communication application.

Operation S203: Determine that the filtered service question is an output data variable of the trigger component, and determine that the output data variable of the trigger component is an input data variable of the question-answering strategy component.

Operation S204: Determine a functional function corresponding to the question-answering strategy component based on the instance template identifier, perform function processing on the input data variable of the question-answering strategy component through the functional function corresponding to the question-answering strategy component, and obtain an output data variable of the question-answering strategy component; and determine that the output data variable of the question-answering strategy component is an input data variable of the language question-answering model component.

The computer device may determine the functional function corresponding to the question-answering strategy component based on the instance template identifier in the performance record table, perform the function processing on the input data variable of the question-answering strategy component through the functional function corresponding to the question-answering strategy component, and determine that the output data variable of the question-answering strategy component is the input data variable of the language question-answering model component.

Specifically, the computer device may use the received service question as the input data variable of the question-answering strategy component through the trigger component. The computer device may determine the functional function corresponding to the question-answering strategy component based on the instance template identifier in the performance record table. For example, a permission determination sub-component in the question-answering strategy component may search, through the functional function userlist.find( ) userlist (a question permission range) that has a questioning permission, and filter a service question that fails to return a result.

The computer device may perform the function processing on the input data variable of the question-answering strategy component through the functional function corresponding to the question-answering strategy component, and obtain the output data variable of the question-answering strategy component (namely the service questions filtered by the question-answering strategy component). The computer device may determine that the output data variable of the question-answering strategy component is the input data variable of the language question-answering model component.

In an embodiment, the question-answering strategy component in the question-answering service includes a question determination sub-component, a frequency control sub-component, and a permission determination sub-component, and the operations of filtering the service question through the question-answering strategy component in the question-answering service, and obtaining a filtered service question include: obtain question-answering statistical information of a user initiating the service question, the question-answering statistical information including a questioning frequency and a questioning permission, the questioning frequency being a frequency at which the user invokes the question-answering service, and the questioning permission being determined based on a user permission of the user; obtain the service question, filter the service question based on a service forbidden word and a question-processing abnormal format that are indicated by the question determination sub-component, and transmit the service question filtered by the question determination sub-component to the frequency control sub-component; filter the service question filtered by the question determination sub-component based on a frequency threshold indicated by the frequency control sub-component and the questioning frequency, and transmit the service question filtered by the frequency control sub-component to the permission determination sub-component; and filter the service question filtered by the frequency control sub-component based on a question permission range indicated by the permission determination sub-component and the questioning permission, and obtain the filtered service question.

A process of filtering the service question by the computer device through the question determination sub-component, the frequency control sub-component, and the permission determination sub-component in the question-answering strategy component may be as follows: obtain the question-answering statistical information of the user initiating the service question, the question-answering statistical information including the questioning frequency and the questioning permission, the questioning frequency being the frequency at which the user invokes the question-answering service, and the questioning permission being determined based on a user permission of the user; obtain the service question, filter the service question based on the service forbidden word and the question-processing abnormal format that are indicated by the question determination sub-component, and transmit the service question filtered by the question determination sub-component to the frequency control sub-component; filter the service question filtered by the question determination sub-component based on the frequency threshold indicated by the frequency control sub-component and the questioning frequency, and transmit the service question filtered by the frequency control sub-component to the permission determination sub-component; and filter the service question filtered by the frequency control sub-component based on the question permission range indicated by the permission determination sub-component and the questioning permission, and transmit the service question filtered by the permission determination sub-component to the language question-answering model component in the question-answering service.

Specifically, the computer device may obtain the question-answering statistical information of the user initiating the service question. The question-answering statistical information includes the questioning frequency and the questioning permission, the questioning frequency is the frequency at which the user invokes the question-answering service, and the questioning permission is determined based on the user permission of the user.

The computer device may obtain the service question (namely the output data variable of the trigger component) transmitted by the trigger component, filter the service question based on the service forbidden word and the question-processing abnormal format that are indicated by the question determination sub-component, and filter the service question that includes the service forbidden word or has a file format of the question-processing abnormal format. The service forbidden word refers to a word that is forbidden from being used in the service question, and may be an illegal word or may be a word that is merely composed of symbols, spaces, etc. and fails to express an actual language meaning. The question-processing abnormal format is specifically set for the selected language question-answering model component. For example, if the selected language question-answering model component may merely process a text message, a file format of the service question that may not be processed by the language question-answering model component, such as a picture and an audio may be set as the question-processing abnormal format.

The computer device may transmit the service question filtered by the question determination sub-component to the frequency control sub-component, filter the service question filtered by the question determination sub-component based on the frequency threshold indicated by the frequency control sub-component and the questioning frequency, and filter the service question from a same user that invokes the question-answering service at a frequency over a filtering threshold indicated by the frequency control sub-component. A unit time range of the frequency of invoking the question-answering service may be one hour, one day, or one week, which is not limited herein.

The computer device may transmit the service question filtered by the frequency control sub-component to the permission determination sub-component, filter the service question filtered by the frequency control sub-component based on the question permission range indicated by the permission determination sub-component and the questioning permission, and filter a service question from the user whose questioning permission falls beyond the question permission range. The questioning permission may alternatively be determined based on the user permission of the user. The user permission refers to that, for example, in the communication application, the user is an administrator or a member of a chat group.

The computer device may transmit the service question filtered by the permission determination sub-component to the language question-answering model component in the question-answering service (it is determined that the service question filtered by the permission determination sub-component is the input data variable of the language question-answering model component). In the embodiment of this application, some service questions are filtered through the question-answering strategy component (may include the question determination sub-component, the frequency control sub-component, and the permission determination sub-component, etc.), such that waste of computation costs of the language question-answering model can be reduced, and quality and production efficiency of the question-answering service can be improved.

Operation S205: Determine a functional function corresponding to the language question-answering model component based on the instance template identifier; and perform function processing on the input data variable of the language question-answering model component through the functional function corresponding to the language question-answering model component, and obtain an output data variable of the language question-answering model component.

The computer device may determine the functional function corresponding to the language question-answering model component based on the instance template identifier in the performance record table, perform the function processing on the input data variable of the language question-answering model component through the functional function corresponding to the language question-answering model component, and determine that the output data variable of the language question-answering model component is the question-answering service result.

Specifically, the computer device may determine the functional function corresponding to the language question-answering model component based on the instance template identifier in the performance record table, and perform the function processing on the input data variable (the service question filtered by the permission determination sub-component) of the language question-answering model component through the functional function corresponding to the language question-answering model component.

In an embodiment, the operations of performing question-answering identification on the filtered service question through the language question-answering model component in the question-answering service, and outputting the question-answering service result include: remove a service stop word from the filtered service question, and obtain an updated service question; perform text division on the updated service question, and obtain N text fragments, N being a positive integer; convert the N text fragments into text word vectors, encode the text word vectors, and obtain contextual information and semantic information of the text word vectors; and perform semantic identification on the contextual information and the semantic information through the language question-answering model component, and obtain the question-answering service result of the service question.

A process that the language question-answering model component may pre-process the filtered service question (including service stop word filtering and text division) through the permission determination sub-component, convert the service question into the text word vector, and then perform the question-answering identification may be as follows: obtain the service question filtered by the question-answering strategy component; remove the service stop word from the filtered service question, and obtain the updated service question; perform the text division on the updated service question, and obtain the N text fragments, N being the positive integer; convert the N text fragments into the text word vectors, encode the text word vectors, and obtain the contextual information and the semantic information of the text word vectors; and perform the semantic identification on the contextual information and the semantic information through the language question-answering model component, and obtain the question-answering service result of the service question.

Specifically, Reference can be made to detailed description of operation S101 in the embodiment of FIG. 4 for the process that the computer device may pre-process the service question filtered by the permission determination sub-component (including the service stop word filtering and the text division) and convert the service question into the text word vector, which will not be repeated herein.

The computer device may encode the text word vectors, and obtain the contextual information and the semantic information of the text word vectors. The contextual information and the semantic information of text word vectors are lemmatized word forms of the text fragments. The computer device may perform the semantic identification on the contextual information and the semantic information through the language question-answering model component, and obtain the question-answering service result of the service question. After the question-answering service is processed, the performance record table also stores the input data variables and the output data variables of the functional code encapsulation components.

Operation S206: Display the question-answering service result of the service question in the question-answering interaction page.

Specifically, the computer device may display the question-answering service result of the service question in the question-answering interaction page of the communication application.

According to the embodiment of this application, the question-answering interaction page is displayed in the communication application, and the service question is inputted into the question-answering interaction page. The service question includes the trigger parameter. The question-answering strategy component in the question-answering service is invoked through the trigger component if the trigger parameter satisfies the question-answering trigger condition indicated by the trigger component. The performance record table is created for the question-answering service based on the trigger component, the question-answering strategy component, and the language question-answering model component that are selected, and the component information of the functional code encapsulation component in the question-answering service is recorded through the performance record table. The component information includes the processing flow connection relationship, and the instance name and the instance template identifier that are configured for representing the functional code encapsulation component in the question-answering service. It is determined that the service question is the output data variable of the trigger component, and it is determined that the output data variable of the trigger component is the input data variable of the question-answering strategy component according to the processing flow connection relationship indicated by the performance record table. The functional function corresponding to the question-answering strategy component is determined based on the instance template identifier in the performance record table, the function processing is performed on the input data variable of the question-answering strategy component through the functional function corresponding to the question-answering strategy component, and the output data variable of the question-answering strategy component is obtained. It is determined that the output data variable of the question-answering strategy component is the input data variable of the language question-answering model component. The functional function corresponding to the language question-answering model component is determined based on the instance template identifier in the performance record table, the function processing is performed on the input data variable of the language question-answering model component through the functional function corresponding to the language question-answering model component, and the output data variable of the language question-answering model component is obtained. It is determined that the output data variable of the language question-answering model component is the question-answering service result. The question-answering service result of the service question is displayed in the question-answering interaction page. Repeated tasks can be performed through the question-answering service, such that the labor costs and manual intervention are reduced. The question-answering service is convenient and easy to operate, such that an implementation error rate can be reduced, the production efficiency can be improved, and competitiveness of enterprises can be improved.

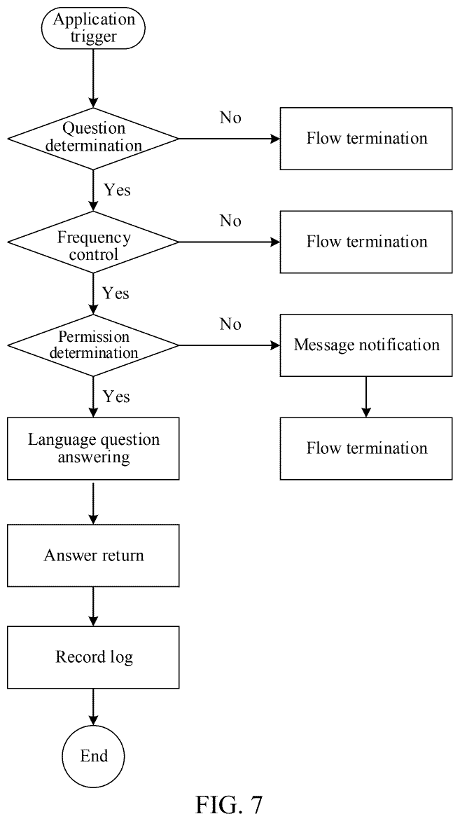

FIG. 7 is a schematic flowchart of a method for generating a question-answering service according to an embodiment of this application. The method for generating a question-answering service may be performed by a computer device, and the computer device may be the terminal device 200 or the work server 100 as shown in FIG. 1. As shown in FIG. 7, the method may include the following operations:

Specifically, the question-answering service edition application in the computer device may graphically render and present the functional code encapsulation components selected by the user through a graphic rendering engine as shown in FIG. 5.

For example, a user may select an application trigger component (the application trigger component may be an initial component of an entire question-answering service workflow. When the user inputs a service question into an independent page of the question-answering service, a function provided by the question-answering service may be activated through the application trigger component, and a question-answering strategy component in the question-answering service may be invoked. The question-answering strategy component may include, for example, a question determination sub-component, a frequency control sub-component, a permission determination sub-component, a language question-answering model component, an answer returning component (displaying a question-answering service result in a question-answering interaction page), a log recording component (recording log information of the functional code encapsulation component in the question-answering service), a message notification component (displaying a message notification in the question-answering interaction page), a flow termination component (terminating a flow when there is an error or abnormality in the question-answering service), and a flow ending component (ending the flow after the question-answering service is completed). The processing flow relationship among the functional code encapsulation components is created as shown in FIG. 7, and the question-answering service is generated by determining the processing flow connection relationship between the selected functional code encapsulation components.

Reference can be made to the description of operation S202 in a corresponding embodiment of FIG. 6 for a specific functional implementation method of the application trigger component in the question-answering service, which will not be repeated herein. The application trigger component may transmit the service question to the question determination sub-component.

Reference can be made to the description of operation S204 in a corresponding embodiment of FIG. 6 for specific functional implementation methods of the question determination sub-component, the frequency control sub-component, and the permission determination sub-component in the question-answering service, which will not be repeated herein. The computer device may determine that flow logic of a service question that includes a service forbidden word or has a file format of a question-processing abnormal format is “No,” and terminate the process of “No.” A service question that excludes the service forbidden word and has a file format other than the question-processing abnormal format is transmitted to the frequency control sub-component. The computer device may determine that flow logic of a service question from a same user whose questioning frequency (a frequency of invoking the question-answering service) exceeds a filtering threshold indicated by the frequency control sub-component is “No,” and terminate the process of “No.” A service question from a user whose questioning frequency is less than or equal to the filtering threshold is transmitted to the permission determination sub-component. The computer device may determine that flow logic of a service question from a user whose questioning permission falls beyond a question permission range is “No,” notify the user of “no questioning permission” in a question-answering interaction page, and terminate the process of “No.” The service question within the question permission range is transmitted to the language question-answering model component, semantic identification is performed on the service question through the language question-answering model component, and a question-answering service result is obtained. The computer device may display the question-answering service result of the service question in the question-answering interaction page through the answer returning component, record the log information of the functional code encapsulation component in the question-answering service through the log recording component, and finally end the flow of the question-answering service.

According to the embodiment of this application, various functional code encapsulation components supporting independent deployment can be provided, the functional code encapsulation components can be accessed flexibly, and the question-answering service can be generated based on the processing flow connection relationship between the functional code encapsulation components selected by the user. In this way, the user without professional programming knowledge can develop the question-answering service through the visual functional code encapsulation components and the processing flow connection relationships instead of writing codes. Thus, development production efficiency and universality of the question-answering service are improved, and development cost and implementation error rates are reduced.

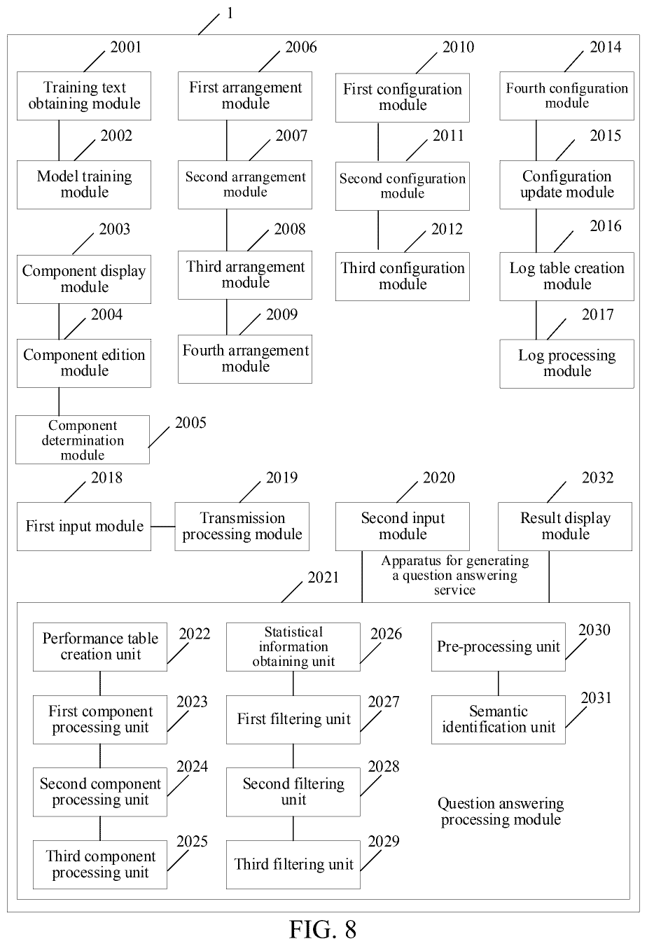

FIG. 8 is a schematic structural diagram of an apparatus for generating a question-answering service according to an embodiment of this application. As shown in FIG. 8, the apparatus 1 for generating a question-answering service includes a training text obtaining module 2001, a model training module 2002, a component display module 2003, a component edition module 2004, a component determination module 2005, a first arrangement module 2006, a second arrangement module 2007, a third arrangement module 2008, a fourth arrangement module 2009, a first configuration module 2010, a second configuration module 2011, a third configuration module 2012, a fourth configuration module 2014, a configuration update module 2015, a log table creation module 2016, a log processing module 2017, a first input module 2018, a transmission processing module 2019, a second input module 2020, a question-answering processing module 2021, and a result display module 2032. The question-answering processing module includes a performance table creation unit 2022, a first component processing unit 2023, a second component processing unit 2024, a third component processing unit 2025, a statistical information obtaining unit 2026, a first filtering unit 2027, a second filtering unit 2028, a third filtering unit 2029, a pre-processing unit 2030, and a semantic identification unit 2031.

The training text obtaining module 2001 is configured to obtain a training text set, filter the service stop word from the training text set, perform text division on the filtered training text set, and obtain M text fragments, M being a positive integer; and count a number of times of occurrence of each text fragment in the M text fragments, and obtain text frequencies corresponding to the M text fragments.

The model training module 2002 is configured to obtain an initial language model, and establish a text dictionary of the initial language model based on the M text fragments and the M text frequencies, the text dictionary including word vectors corresponding to the M text fragments; obtain a question-answering sample, and establish a question-answering word vector corresponding to the question-answering sample based on the text dictionary; and train the initial language model based on the question-answering word vector, and obtain the language question-answering model component.

Reference can be made to the description of operation S101 in a corresponding embodiment of FIG. 4 for specific functional implementation methods of the training text obtaining module 2001 and the model training module 2002, which will not be repeated herein.

The component display module 2003 is configured to display a functional code encapsulation component set in an edition interaction page of a question-answering service edition application, the functional code encapsulation component set including a plurality of functional code encapsulation components, and the plurality of functional code encapsulation components including at least one trigger component, at least one question-answering strategy component, and at least one language question-answering model component. Reference can be made to the description of operation S101 in a corresponding embodiment of FIG. 4 for a specific functional implementation method of the component display module 2003, which will not be repeated herein.

The component edition module 2004 is configured to display, in response to a component selection operation on the functional code encapsulation component set, the trigger component, the question-answering strategy component, and the language question-answering model component that are selected through the component selection operation in a question-answering service edition page included in the edition interaction page, the question-answering service edition page being further configured to display a processing flow connection relationship among the trigger component, the question-answering strategy component, and the language question-answering model component that are selected. Reference can be made to the description of operation S102 in a corresponding embodiment of FIG. 4 for specific functional implementation methods of the component edition module 2004, which will not be repeated herein.

The component determination module 2005 is configured to generate, in response to a question-answering service confirmation operation triggered in the edition interaction page of the question-answering service edition application, the question-answering service based on the processing flow connection relationship among the trigger component, the question-answering strategy component, and the language question-answering model component that are selected, the trigger component in the question-answering service being configured to invoke the question-answering strategy component from the question-answering service, the question-answering strategy component in the question-answering service being configured to perform, after receiving a service question, question-answering filtering on the service question, and the language question-answering model component in the question-answering service being configured to output a question-answering service result according to a filtered service question. Reference can be made to the description of operation S103 in a corresponding embodiment of FIG. 4 for a specific functional implementation method of the component determination module 2005, which will not be repeated herein.

The first arrangement module 2006 is configured to create, in response to a first component arrangement operation on the functional code encapsulation components selected from the question-answering service edition page, the processing flow connection relationship between the trigger component and the question-answering strategy component that are selected; and determine that the selected trigger component is the functional code encapsulation component configured to perform an initial flow of the question-answering service, and determine that the selected question-answering strategy component is the functional code encapsulation component configured to perform a next flow of the trigger component based on the processing flow connection relationship between the trigger component and the question-answering strategy component that are selected.

The second arrangement module 2007 is configured to create, in response to a second component arrangement operation on the functional code encapsulation components selected from the question-answering service edition page, the processing flow connection relationship between the question-answering strategy component and the language question-answering model component that are selected; and determine, based on the processing flow connection relationship between the question-answering strategy component and the language question-answering model component that are selected, that the selected language question-answering model component is the functional code encapsulation component configured to perform a next flow of the question-answering strategy component.

The third arrangement module 2008 is configured to create, in response to a third component arrangement operation on the question determination sub-component and the frequency control sub-component that are selected from the question-answering service edition page, a processing flow connection relationship between the question determination sub-component and the frequency control sub-component that are selected; and determine that the selected question determination sub-component is the functional code encapsulation component configured to perform an initial flow of the question-answering strategy component, and determine that the selected frequency control sub-component is the functional code encapsulation component configured to perform a next flow of the question determination sub-component based on the processing flow connection relationship between the question determination sub-component and the frequency control sub-component that are selected.

The fourth arrangement module 2009 is configured to create, in response to a fourth component arrangement operation on the frequency control sub-component and the permission determination sub-component that are selected from the question-answering service edition page, a processing flow connection relationship between the frequency control sub-component and the permission determination sub-component that are selected; and determine, based on the processing flow connection relationship between the frequency control sub-component and the permission determination sub-component that are selected, that the selected permission determination sub-component is the functional code encapsulation component configured to perform a next flow of the frequency control sub-component.

Reference can be made to the description of operation S102 in a corresponding embodiment of FIG. 4 for specific functional implementation methods of the first arrangement module 2006, the second arrangement module 2007, the third arrangement module 2008, and the fourth arrangement module 2009, which will not be repeated herein.

The first configuration module 2010 is configured to configure, in response to a first component configuration operation on the question determination sub-component selected from the question-answering service edition page, a service forbidden word and a question-processing abnormal format of the selected question determination sub-component in a parameter configuration page in the edition interaction page.

The second configuration module 2011 is configured to configure, in response to a second component configuration operation on the frequency control sub-component selected from the question-answering service edition page, a frequency threshold of the selected frequency control sub-component in the parameter configuration page.

The third configuration module 2012 is configured to configure, in response to a third component configuration operation on the permission determination sub-component selected from the question-answering service edition page, a question permission range of the selected permission determination sub-component in the parameter configuration page.

The fourth configuration module 2014 is configured to display, in response to a component configuration operation on the functional code encapsulation component selected from the question-answering service edition page, a plurality of instance template identifiers in the parameter configuration page in the edition interaction page; and determine a target instance template identifier from the plurality of instance template identifiers.

The configuration update module 2015 is configured to update the selected functional code encapsulation component in the question-answering service edition page based on the target instance template identifier, the instance template identifier being configured to determine a functional function corresponding to the functional code encapsulation component, and the functional function being configured to perform function processing on the service question.

Reference can be made to the description of operation S102 in a corresponding embodiment of FIG. 4 for specific functional implementation methods of the first configuration module 2010, the second configuration module 2011, the third configuration module 2012, the fourth configuration module 2014, and the configuration update module 2015, which will not be repeated herein.

The log table creation module 2016 is configured to create a performance log table for the question-answering service based on the trigger component, the question-answering strategy component, and the language question-answering model component that are selected; and record log information of the functional code encapsulation component in the question-answering service through the performance log table.

The log processing module 2017 is configured to perform statistics on a running state and service quality quantification data of the question-answering service according to the log information; and adjust at least one of the trigger component, the question-answering strategy component, the language question-answering model component, or the processing flow connection relationship based on the running state and the service quality quantification data of the question-answering service.

Reference can be made to the description of operation S103 in a corresponding embodiment of FIG. 4 for specific functional implementation methods of the log table creation module 2016 and the log processing module 2017, which will not be repeated herein.

The first input module 2018 is configured to display the question-answering interaction page of the question-answering service in the communication application, and obtain the service question inputted into the question-answering interaction page, the service question including the trigger parameter.

The transmission processing module 2019 is configured to obtain a message credential through the trigger component if the trigger parameter satisfies a question-answering trigger condition indicated by the trigger component; transmit the service question and the message credential to a communication server, cause the communication server to encrypt the service question according to the message credential, and obtain an encrypted ciphertext; and transmit the encrypted ciphertext to a work server, the message credential being further stored in the work server, the work server being configured to decrypt, with the stored message credential, the encrypted ciphertext to obtain the service question, and the work server being further configured to output, through the question-answering service, the question-answering service result corresponding to the service question.

Reference can be made to the description of operation S202 in a corresponding embodiment of FIG. 6 for specific functional implementation methods of the first input module 2018 and the transmission processing module 2019, which will not be repeated herein.

The second input module 2020 is configured to display the question-answering interaction page of the question-answering service in the communication application, and obtain the service question inputted into the question-answering interaction page, the service question including the trigger parameter. Reference can be made to the description of operation S202 in a corresponding embodiment of FIG. 6 for a specific functional implementation method of the second input module 2020, which will not be repeated herein.

The question-answering processing module 2021 is configured to invoke the question-answering strategy component in the question-answering service through the trigger component if the trigger parameter satisfies a question-answering trigger condition indicated by the trigger component.

The question-answering processing module 2021 is further configured to filter the service question through the question-answering strategy component in the question-answering service, and obtain a filtered service question.

In an embodiment, the question-answering processing module 2021 is further configured to perform question-answering identification on the filtered service question through the language question-answering model component in the question-answering service, and output the question-answering service result.

In an embodiment, the result display module 2032 is further configured to display the question-answering service result of the service question in the question-answering interaction page.

The performance table creation unit 2022 is configured to obtain a performance record table of the question-answering service, the performance record table including an instance template identifier.

The performance table creation unit 2022 may specifically create the performance record table for the question-answering service based on the trigger component, the question-answering strategy component, and the language question-answering model component that are selected, and record the component information of the functional code encapsulation component in the question-answering service through the performance record table, the component information including the processing flow connection relationship, and the instance name and the instance template identifier that are configured for representing the functional code encapsulation component in the question-answering service. Reference can be made to the description of operation S201 in a corresponding embodiment of FIG. 6 for a specific functional implementation method of the performance table creation unit 2022, which will not be repeated herein.

The first component processing unit 2023 is configured to determine that the filtered service question is an output data variable of the trigger component, and determine that the output data variable of the trigger component is an input data variable of the question-answering strategy component.

The first component processing unit 2023 may be specifically configured to determine that the service question is the output data variable of the trigger component, and determine that the output data variable of the trigger component is the input data variable of the question-answering strategy component according to the processing flow connection relationship indicated by the performance record table. Reference can be made to the description of operation S203 in a corresponding embodiment of FIG. 6 for a specific functional implementation method of the first component processing unit 2023, which will not be repeated herein.

The second component processing unit 2024 is configured to determine a functional function corresponding to the question-answering strategy component based on the instance template identifier, perform function processing on the input data variable of the question-answering strategy component through the functional function corresponding to the question-answering strategy component, and obtain an output data variable of the question-answering strategy component; and determine that the output data variable of the question-answering strategy component is an input data variable of the language question-answering model component.

Reference can be made to the description of operation S204 in a corresponding embodiment of FIG. 6 for a specific functional implementation method of the second component processing unit 2024, which will not be repeated herein.

The third component processing unit 2025 is configured to determine a functional function corresponding to the language question-answering model component based on the instance template identifier; perform function processing on the input data variable of the language question-answering model component through the functional function corresponding to the language question-answering model component, and obtain an output data variable of the language question-answering model component; and determine that the output data variable of the language question-answering model component is the question-answering service result.

The third component processing unit 2025 may be specifically configured to determine the functional function corresponding to the language question-answering model component based on the instance template identifier in the performance record table, perform the function processing on the input data variable of the language question-answering model component through the functional function corresponding to the language question-answering model component, obtain the output data variable of the language question-answering model component, and determine that the output data variable of the language question-answering model component is the question-answering service result, the performance record table being further configured to store the input data variable and the output data variable of the functional code encapsulation component in the question-answering service. Reference can be made to the description of operation S205 in a corresponding embodiment of FIG. 6 for a specific functional implementation method of the third component processing unit 2025, which will not be repeated herein.

The statistical information obtaining unit 2026 is configured to obtain question-answering statistical information of a user initiating the service question, the question-answering statistical information including a questioning frequency and a questioning permission, the questioning frequency being a frequency at which the user invokes the question-answering service, and the questioning permission being determined based on a user permission of the user.

The first filtering unit 2027 is configured to obtain the service question, filter the service question based on the service forbidden word and the question-processing abnormal format that are indicated by the question determination sub-component, and transmit the service question filtered by the question determination sub-component to the frequency control sub-component.

The second filtering unit 2028 is configured to filter the service question filtered by the question determination sub-component based on a frequency threshold indicated by the frequency control sub-component and the questioning frequency, and transmit the service question filtered by the frequency control sub-component to the permission determination sub-component.

The third filtering unit 2029 is configured to filter the service question filtered by the frequency control sub-component based on a question permission range indicated by the permission determination sub-component and the questioning permission, and obtain the filtered service question.

Reference can be made to the description of operation S204 in a corresponding embodiment of FIG. 6 for specific functional implementation methods of the first filtering unit 2027, the second filtering unit 2028, and the third filtering unit 2029, which will not be repeated herein.

The pre-processing unit 2030 is configured to remove a service stop word from the filtered service question, and obtain an updated service question; and perform text division on the updated service question, and obtain N text fragments, N being a positive integer.

The semantic identification unit 2031 is configured to convert the N text fragments into text word vectors, encode the text word vectors, and obtain contextual information and semantic information of the text word vectors; and perform semantic identification on the contextual information and the semantic information through the language question-answering model component, and obtain the question-answering service result of the service question.

Reference can be made to the description of operation S205 in a corresponding embodiment of FIG. 6 for specific functional implementation methods of the pre-processing unit 2030 and the semantic identification unit 2031, which will not be repeated herein.

The result display module 2032 is configured to display the question-answering service result of the service question in the question-answering interaction page. Reference can be made to the description of operation S206 in a corresponding embodiment of FIG. 6 for a specific functional implementation method of the result display module 2032, which will not be repeated herein.

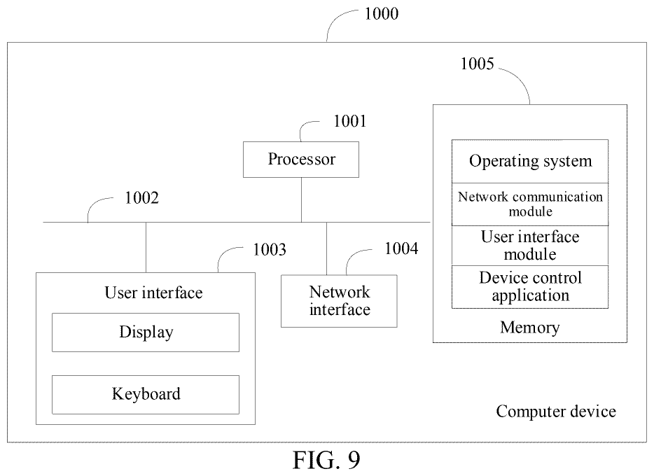

FIG. 9 is a schematic structural diagram showing a computer device according to an embodiment of this application. As shown in FIG. 9, the computer device 1000 may include: a processor 1001, a network interface 1004, and a memory 1005. In addition, the computer device 1000 may also include: a user interface 1003, and at least one communication bus 1002. The communication bus 1002 is configured to implement connection communication between these components. The user interface 1003 may include a display and a keyboard, and in some embodiment, the user interface 1003 may also include a standard wired interface and a wireless interface. In some embodiments, the network interface 1004 may include a standard wired interface and a wireless interface (such as a WI-FI interface). The memory 1005 may be a high-speed random-access memory (RAM) or a non-volatile memory, such as at least one disk memory. In some embodiments, the memory 1005 may be at least one storage device located far away from the aforementioned processor 1001. As shown in FIG. 9, the memory 1005 as a computer-readable storage medium may include an operating system, a network communication module, a user interface module, and a device control application.

In the computer device 1000 shown in FIG. 9, the network interface 1004 may provide a network communication network element. The user interface 1003 is mainly configured to provide an input interface for the user. The processor 1001 may be configured to invoke the device control application stored in the memory 1005 to:
display a functional code encapsulation component set in an edition interaction page of a question-answering service edition application, the functional code encapsulation component set including a plurality of functional code encapsulation components, and the plurality of functional code encapsulation components including at least one trigger component, at least one question-answering strategy component, and at least one language question-answering model component;
display, in response to a component selection operation on the functional code encapsulation component set, the trigger component, the question-answering strategy component, and the language question-answering model component that are selected through the component selection operation in a question-answering service edition page included in the edition interaction page, the question-answering service edition page being further configured to display a processing flow connection relationship among the trigger component, the question-answering strategy component, and the language question-answering model component that are selected; and
generate, in response to a question-answering service confirmation operation triggered in the edition interaction page of the question-answering service edition application, the question-answering service based on the processing flow connection relationship among the trigger component, the question-answering strategy component, and the language question-answering model component that are selected, the trigger component in the question-answering service being configured to invoke the question-answering strategy component from the question-answering service, the question-answering strategy component in the question-answering service being configured to perform, after receiving a service question, question-answering filtering on the service question, and the language question-answering model component in the question-answering service being configured to output a question-answering service result according to a filtered service question.

The computer device 1000 described in the embodiment of this application may perform the description of the method for generating a question-answering service according to any corresponding embodiment of FIG. 4, FIG. 6 and FIG. 7, which is not repeated herein. In addition, the description of beneficial effects produced by the same method will not be repeated herein.

In addition, the embodiments of this application further provide a computer-readable storage medium. The computer-readable storage medium has a computer-readable instruction stored therein, and the computer-readable instruction, when executed by a processor, may perform the description of the method for generating a question-answering service according to any corresponding embodiment of FIG. 4, FIG. 6, and FIG. 7, which will not be repeated herein. In addition, the description of beneficial effects produced by the same method will not be repeated herein. Reference can be made to the description of the method embodiment of this application for the technical details that are not disclosed in the computer-readable storage medium embodiment involved in this application.

The computer-readable storage medium may be the apparatus for generating a question-answering service according to any aforementioned embodiment or an internal storage unit of the computer device, such as the hard disk or an internal memory of the computer device. The computer-readable storage medium may also be an external storage device of the computer device, for example, a plug-in hard disk disposed on the computer device, a smart media card (SMC), a secure digital (SD) card, a flash card, etc. Further, the computer-readable storage medium may also include the internal storage unit of the computer device and an external storage device. The computer-readable storage medium is configured to store the computer-readable instruction and other programs and data required by the computer device. The computer-readable storage medium may also be configured to temporarily store data that has been displayed or will be displayed.

In addition, the embodiment of this application further provides a computer program product. The computer program product includes a computer-readable instruction. The computer-readable instruction is stored in a computer-readable storage medium. A processor of the computer device reads the computer-readable instruction from the computer-readable storage medium, and the processor, when executing the computer-readable instruction, causes the computer device to perform the method according to any corresponding embodiment of FIG. 4, FIG. 6, and FIG. 7.

The terms “first,” “second,” etc. in the description, and the claims and the accompanying drawings of the embodiments of this application are used to distinguish different objects, rather than describe a specific order. In addition, the terms “comprise,” “include” and any form of variation thereof are intended to cover non-exclusive inclusions. For example, a process, a method, an apparatus, a product, or a device that includes a series of steps or units is not limited to listed steps or modules, but may include steps or modules that are not listed, or may include other step units inherent to these processes, methods, devices, products, or devices in some embodiments.

Those skilled in the art are to be able to realize that steps of the units and algorithms of the examples described with reference to the embodiments disclosed herein can be implemented in electronic hardware, computer software or their combination. To clearly illustrate the interchangeability of hardware and software, the compositions and steps of the examples have been generally described in terms of elements in the above description. Whether these elements are performed by hardware or software depends on the specific application and design constraints of the technical solution. Those skilled in the art can use different methods to implement the described elements for each particular application, but such implementation is not to be considered to fall beyond the scope of this application.

The technical features of the embodiments described above can be combined in different manners to form other embodiments. To simplify description, not all possible combinations of the features of the embodiments described above are described. However, the combinations of these technical features are to fall within the scope in the description as long as no conflict exists.

The embodiments described above are merely several types of implementations of this application, and are specifically described in detail, but cannot be interpreted as limitation to the scope of the patent for the invention as a result. For those skilled in the art, several variations and improvements can also be made without departing from the concept of this application, and are to fall within the scope of this application. Hence, the protection scope of the patent for this application is to be subject to the appended claims.

What is claimed is:

1. A question-answering service generation method, performed by a computer device, comprising:
displaying a functional code encapsulation component set in an edition interaction page of a question-answering service edition application;
in response to a component selection operation on the functional code encapsulation component set, displaying, in a question-answering service edition page included in the edition interaction page:
a trigger component, a question-answering strategy component, and a language question-answering model component that are selected from the functional code encapsulation component set through the component selection operation, and
a processing flow connection relationship among the trigger component, the question-answering strategy component, and the language question-answering model component; and
generating, in response to a question-answering service confirmation operation triggered in the edition interaction page, a question-answering service based on the processing flow connection relationship, the trigger component in the question-answering service being configured to invoke the question-answering strategy component from the question-answering service, the question-answering strategy component in the question-answering service being configured to perform, after receiving a service question, question-answering filtering on the service question to obtain a filtered service question, and the language question-answering model component in the question-answering service being configured to output a question-answering service result according to the filtered service question.

2. The method according to claim 1, further comprising:
displaying a question-answering interaction page of the question-answering service in a communication application;
obtaining a service question inputted into the question-answering interaction page, the service question including a trigger parameter;
obtaining a message credential through the trigger component in response to the trigger parameter satisfying a question-answering trigger condition indicated by the trigger component; and
transmitting the service question and the message credential to a communication server, causing the communication server to encrypt the service question according to the message credential to obtain an encrypted ciphertext and transmit the encrypted ciphertext to a work server, for the work server to decrypt the encrypted ciphertext through the message credential stored in the work server to obtain the service question, and to output the question-answering service result through the question-answering service.

3. The method according to claim 1, further comprising:
displaying a question-answering interaction page of the question-answering service in a communication application;
obtaining a service question inputted into the question-answering interaction page, the service question including a trigger parameter;
invoking the question-answering strategy component in the question-answering service through the trigger component in response to the trigger parameter satisfying a question-answering trigger condition indicated by the trigger component;
filtering the service question through the question-answering strategy component in the question-answering service to obtain the filtered service question;
performing question-answering identification on the filtered service question through the language question-answering model component in the question-answering service to obtain the question-answering service result; and
displaying the question-answering service result in the question-answering interaction page.

4. The method according to claim 3, further comprising:
obtaining a performance record table of the question-answering service, the performance record table including an instance template identifier;
wherein performing the question-answering identification includes:
determining a first functional function corresponding to the question-answering strategy component and a second functional function corresponding to the language question-answering model component based on the instance template identifier;
performing function processing on the filtered service question through the first functional function to obtain an output data variable of the question-answering strategy component; and
performing function processing on the output data variable of the question-answering strategy component through the second functional function to obtain the question-answering service result.

5. The method according to claim 3, wherein performing the question-answering identification includes:
removing a service stop word from the filtered service question to obtain an updated service question;
performing text division on the updated service question to obtain one or more text fragments;
converting the one or more text fragments into one or more text word vectors, respectively;
encoding the one or more text word vectors to obtain contextual information and semantic information of the one or more text word vectors; and
performing semantic identification on the contextual information and the semantic information through the language question-answering model component to obtain the question-answering service result.

6. The method according to claim 3, wherein:
the question-answering strategy component in the question-answering service includes a question determination sub-component, a frequency control sub-component, and a permission determination sub-component; and
filtering the service question includes:
obtaining question-answering statistical information of a user initiating the service question, the question-answering statistical information including:
a questioning frequency at which the user invokes the question-answering service, and
a questioning permission determined based on a user permission of the user;
filtering the service question based on a service forbidden word and a question-processing abnormal format that are indicated by the question determination sub-component, and transmitting the service question filtered by the question determination sub-component to the frequency control sub-component;
filtering the service question filtered by the question determination sub-component based on a frequency threshold indicated by the frequency control sub-component and the questioning frequency, and transmitting the service question filtered by the frequency control sub-component to the permission determination sub-component; and
filtering the service question filtered by the frequency control sub-component based on a question permission range indicated by the permission determination sub-component and the questioning permission, to obtain the filtered service question.

7. The method according to claim 1, further comprising:
configuring, in response to a first component configuration operation on a question determination sub-component selected in the question-answering service edition page, a service forbidden word and a question-processing abnormal format of the question determination sub-component in a parameter configuration page in the edition interaction page;
configuring, in response to a second component configuration operation on a frequency control sub-component selected in the question-answering service edition page, a frequency threshold of the frequency control sub-component in the parameter configuration page; and
configuring, in response to a third component configuration operation on a permission determination sub-component selected in the question-answering service edition page, a question permission range of the permission determination sub-component in the parameter configuration page.

8. The method according to claim 1, further comprising:
displaying, in response to a component configuration operation on a functional code encapsulation component selected in the question-answering service edition page, a plurality of instance template identifiers in a parameter configuration page in the edition interaction page, each of the plurality of instance template identifiers being configured to determine a functional function corresponding to the functional code encapsulation component that is configured to perform function processing on the service question;
determining a target instance template identifier from the plurality of instance template identifiers; and
updating the functional code encapsulation component in the question-answering service edition page based on the target instance template identifier.

9. The method according to claim 1, further comprising:
creating, in response to a first component arrangement operation on functional code encapsulation components selected in the question-answering service edition page, a processing flow connection relationship between the trigger component and the question-answering strategy component;
determining the trigger component as a functional code encapsulation component configured to perform an initial flow of the question-answering service, and determining the question-answering strategy component as a functional code encapsulation component configured to perform a next flow of the trigger component, based on the processing flow connection relationship between the trigger component and the question-answering strategy component;
creating, in response to a second component arrangement operation on the functional code encapsulation components selected in the question-answering service edition page, a processing flow connection relationship between the question-answering strategy component and the language question-answering model component; and
determining the language question-answering model component as a functional code encapsulation component configured to perform a next flow of the question-answering strategy component based on the processing flow connection relationship between the question-answering strategy component and the language question-answering model component.

10. The method according to claim 1,
wherein the question-answering strategy component includes a question determination sub-component, a frequency control sub-component, and a permission determination sub-component;
the method further comprising:
creating, in response to a first component arrangement operation on the question determination sub-component and the frequency control sub-component, a processing flow connection relationship between the question determination sub-component and the frequency control sub-component;
determining the question determination sub-component as a functional code encapsulation component configured to perform an initial flow of the question-answering strategy component, and determining the frequency control sub-component as a functional code encapsulation component configured to perform a next flow of the question determination sub-component, based on the processing flow connection relationship between the question determination sub-component and the frequency control sub-component;
creating, in response to a second component arrangement operation on the frequency control sub-component and the permission determination sub-component, a processing flow connection relationship between the frequency control sub-component and the permission determination sub-component; and
determining the permission determination sub-component as a functional code encapsulation component configured to perform a next flow of the frequency control sub-component based on the processing flow connection relationship between the frequency control sub-component and the permission determination sub-component.

11. The method according to claim 1, further comprising:
obtaining a training text set, filtering service stop word from the training text set to obtain a filtered training text set, and performing text division on the filtered training text set to obtain M text fragments, M being a positive integer;
counting a number of times of occurrence of each of the M text fragments to obtain M text frequencies corresponding to the M text fragments, respectively;
obtaining an initial language model, and establishing a text dictionary of the initial language model based on the M text fragments and the M text frequencies, the text dictionary including word vectors corresponding to the M text fragments;
obtaining a question-answering sample, and establishing a question-answering word vector corresponding to the question-answering sample based on the text dictionary; and
training the initial language model based on the question-answering word vector to obtain the language question-answering model component.

12. The method according to claim 1, further comprising:
creating a performance log table for the question-answering service based on the trigger component, the question-answering strategy component, and the language question-answering model component;
recording log information of a functional code encapsulation component in the question-answering service through the performance log table;
performing statistics on a running state and service quality quantification data of the question-answering service according to the log information; and
adjusting at least one of the trigger component, the question-answering strategy component, the language question-answering model component, or the processing flow connection relationship based on the running state and the service quality quantification data.

13. A computer device comprising:
a processor; and
a memory storing computer-readable instructions that, when executed by the processor, cause the computer device to:
display a functional code encapsulation component set in an edition interaction page of a question-answering service edition application;
in response to a component selection operation on the functional code encapsulation component set, display, in a question-answering service edition page included in the edition interaction page:
a trigger component, a question-answering strategy component, and a language question-answering model component that are selected from the functional code encapsulation component set through the component selection operation, and
a processing flow connection relationship among the trigger component, the question-answering strategy component, and the language question-answering model component; and
generate, in response to a question-answering service confirmation operation triggered in the edition interaction page, a question-answering service based on the processing flow connection relationship, the trigger component in the question-answering service being configured to invoke the question-answering strategy component from the question-answering service, the question-answering strategy component in the question-answering service being configured to perform, after receiving a service question, question-answering filtering on the service question to obtain a filtered service question, and the language question-answering model component in the question-answering service being configured to output a question-answering service result according to the filtered service question.

14. The computer device according to claim 13, wherein the computer-readable instructions, when executed by the processor, further cause the computer device to:
display a question-answering interaction page of the question-answering service in a communication application;
obtain a service question inputted into the question-answering interaction page, the service question including a trigger parameter;
obtain a message credential through the trigger component in response to the trigger parameter satisfying a question-answering trigger condition indicated by the trigger component; and
transmit the service question and the message credential to a communication server, causing the communication server to encrypt the service question according to the message credential to obtain an encrypted ciphertext and transmit the encrypted ciphertext to a work server, for the work server to decrypt the encrypted ciphertext through the message credential stored in the work server to obtain the service question, and to output the question-answering service result through the question-answering service.

15. The computer device according to claim 13, wherein the computer-readable instructions, when executed by the processor, further cause the computer device to:
display a question-answering interaction page of the question-answering service in a communication application;
obtain a service question inputted into the question-answering interaction page, the service question including a trigger parameter;
invoke the question-answering strategy component in the question-answering service through the trigger component in response to the trigger parameter satisfying a question-answering trigger condition indicated by the trigger component;
filter the service question through the question-answering strategy component in the question-answering service to obtain the filtered service question;
perform question-answering identification on the filtered service question through the language question-answering model component in the question-answering service to obtain the question-answering service result; and
display the question-answering service result in the question-answering interaction page.

16. The computer device according to claim 15, wherein the computer-readable instructions, when executed by the processor, further cause the computer device to:
obtain a performance record table of the question-answering service, the performance record table including an instance template identifier; and
when performing the question-answering identification:
determine a first functional function corresponding to the question-answering strategy component and a second functional function corresponding to the language question-answering model component based on the instance template identifier;
perform function processing on the filtered service question through the first functional function to obtain an output data variable of the question-answering strategy component; and
perform function processing on the output data variable of the question-answering strategy component through the second functional function to obtain the question-answering service result.

17. The computer device according to claim 15, wherein the computer-readable instructions, when executed by the processor, further cause the computer device to, when performing the question-answering identification:
remove a service stop word from the filtered service question to obtain an updated service question;
perform text division on the updated service question to obtain one or more text fragments;
convert the one or more text fragments into one or more text word vectors, respectively;
encode the one or more text word vectors to obtain contextual information and semantic information of the one or more text word vectors; and
perform semantic identification on the contextual information and the semantic information through the language question-answering model component to obtain the question-answering service result.

18. The computer device according to claim 15, wherein:
the question-answering strategy component in the question-answering service includes a question determination sub-component, a frequency control sub-component, and a permission determination sub-component; and
the computer-readable instructions, when executed by the processor, further cause the computer device to, when filtering the service question:
obtain question-answering statistical information of a user initiating the service question, the question-answering statistical information including:
a questioning frequency at which the user invokes the question-answering service, and
a questioning permission determined based on a user permission of the user;
filter the service question based on a service forbidden word and a question-processing abnormal format that are indicated by the question determination sub-component, and transmitting the service question filtered by the question determination sub-component to the frequency control sub-component;
filter the service question filtered by the question determination sub-component based on a frequency threshold indicated by the frequency control sub-component and the questioning frequency, and transmitting the service question filtered by the frequency control sub-component to the permission determination sub-component; and
filter the service question filtered by the frequency control sub-component based on a question permission range indicated by the permission determination sub-component and the questioning permission, to obtain the filtered service question.

19. The computer device according to claim 13, wherein the computer-readable instructions, when executed by the processor, further cause the computer device to:
configure, in response to a first component configuration operation on a question determination sub-component selected in the question-answering service edition page, a service forbidden word and a question-processing abnormal format of the question determination sub-component in a parameter configuration page in the edition interaction page;
configure, in response to a second component configuration operation on a frequency control sub-component selected in the question-answering service edition page, a frequency threshold of the frequency control sub-component in the parameter configuration page; and
configure, in response to a third component configuration operation on a permission determination sub-component selected in the question-answering service edition page, a question permission range of the permission determination sub-component in the parameter configuration page.

20. A non-transitory computer-readable storage medium storing computer-readable instructions that, when executed by a processor, cause a computer device having the processor to:
display a functional code encapsulation component set in an edition interaction page of a question-answering service edition application;
in response to a component selection operation on the functional code encapsulation component set, display, in a question-answering service edition page included in the edition interaction page:
a trigger component, a question-answering strategy component, and a language question-answering model component that are selected from the functional code encapsulation component set through the component selection operation, and
a processing flow connection relationship among the trigger component, the question-answering strategy component, and the language question-answering model component; and
generate, in response to a question-answering service confirmation operation triggered in the edition interaction page, a question-answering service based on the processing flow connection relationship, the trigger component in the question-answering service being configured to invoke the question-answering strategy component from the question-answering service, the question-answering strategy component in the question-answering service being configured to perform, after receiving a service question, question-answering filtering on the service question to obtain a filtered service question, and the language question-answering model component in the question-answering service being configured to output a question-answering service result according to the filtered service question.
